(19) United States
(12) Patent Application Publication
(10) Pub. No.: US 2014/0172321 A1
(43) Pub. Date: Jun. 19, 2014

(54) LEUKEMIA CLASSIFICATION USING CPD DATA

(71) Applicant: Beckman Coulter, Inc., Brea, CA (US)

(72) Inventor: Kyungja Han, Seoul (KR)

(73) Assignee: Beckman Coulter, Inc., Brea, CA (US)

(21) Appl. No.: 13/965,838

(22) Filed: Aug. 13, 2013

Related U.S. Application Data
(60) Provisional application No. 61/682,545, filed on Aug. 13, 2012.

(51) Int. Cl. G01N 15/14; G06F 19/00

(52) U.S. Cl. CPC G01N 15/1436; G06F 19/34
USPC 702/21

(57) ABSTRACT

Embodiments of the present invention encompass automated systems and methods for predicting an acute leukemia sub-type of an individual diagnosed with acute leukemia based on a biological sample obtained from blood of the individual. Exemplary techniques involve correlating aspects of direct current (DC) impedance, radiofrequency (RF) conductivity, and/or light measurement data obtained from the biological sample with an acute leukemic sub-type of the individual.

### CROSS-REFERENCES TO RELATED APPLICATIONS

This application claims the benefit of priority to U.S. Provisional Patent Application No. 61/682,545 filed Aug. 13, 2012, which is herein incorporated by reference in its entirety for all purposes. This application is also related to U.S. Pat. No. 8,094,299. The content of each of the above filings is incorporated herein by reference.

### BACKGROUND OF THE INVENTION

Embodiments of the present invention relate generally to the field of acute leukemia diagnosis and treatment, and in particular to systems and methods for identifying or predicting an acute leukemia sub-type in an individual diagnosed with acute leukemia.

Acute leukemias are a heterogenous group of malignancies characterized by proliferation of immature hematopoietic precursor cells. Acute leukemias can occur in any age, with a predominance of lymphoblastic leukemias in children, while myeloid malignancies are more common in adults. The classification of acute leukemias is very complex, and can take into account information obtained from various laboratory techniques, such as morphologic review of the leukemic blasts, review of bone marrow biopsy specimens, immunophenotyping by flow cytometry, and identification of specific cytogenetic and molecular abnormalities.

For many years, cellular morphology was one of the most important sources of diagnostic information provided by the hematology laboratory. Microscopic review of all blood samples was routine practice, and thus allowed the medical community to gather a vast body of knowledge on how cells change in various disease states. However, with the increasing workload and economic pressures laboratories have faced over the past decades, along with the advent of automated cell counters capable of automatically reporting out a CBC with differential, the diagnostic use of morphologic information has steadily decreased as today only a minority of blood samples actually come under the microscope. The same is true when it comes to the differential diagnosis of the various sub-types of acute leukemias. Historically, the sub-classification of blasts into lymphoid or myeloid lineage, and the identification of promyelocytic leukemia, was based predominantly on information provided by blast morphology. Hematologists and pathologists relied on features such as the abundance of cytoplasm, the nuclear to cytoplasmic ratio, the presence of cytoplasmic granules and possible Auer rods, and the number and size of nucleoli, in order to determine the lineage of a case, and thus guide therapy and predict prognosis. While this was the standard of care for many years, the serious limitations of this approach cannot be overstated. Morphologic analysis by a human being is subjective and heavily dependent on the personal experience of the reviewer, the number of blasts that are analyzed is limited to a few hundred cells, and the correct identification of features pointing to either myeloid or lymphoid lineage is very poorly reproducible. From the practical perspective, this is a very time consuming and expensive approach, to the point that Auer rods are sometimes referred to as “hour” rods, in reference to the amount of time it may take a reviewer to find one. For these reasons, morphology was largely replaced initially by cytochemistry, and later by flow cytometry immunophenotyping, as the standard of care method for the sub-classification of acute leukemias.

Hence, over the past decades, the prognosis for patients suffering from all types of acute leukemias has improved significantly, as standardized treatment protocols have been developed which concurrently allow for higher remission rates, minimize acute toxicities, and also have lower risks of late occurring complications. This success is due in great part to a better understanding of the pathophysiology and etiology of the various sub-types of acute leukemias, and to newer diagnostic techniques allowing for more precise and reproducible sub-classification of individual disease sub-types.

Despite such advances, significant challenges remain in the field of diagnosing and treating acute leukemic patients. For example, currently used initial discrimination procedures often rely on morphology and flow cytometry results performed either in the peripheral blood, or on bone marrow aspirate material, and typically involves navigating a complex complete classification tree for acute leukemias. Moreover, flow cytometry is not readily available in all hospitals and laboratories as it requires modern instrumentation and specialized technologists and pathologists. In smaller institutions, samples are typically sent to a reference laboratory, and results may not be available for a couple of days. Even in large academic institutions the flow cytometry service typically operates on regular work hours, which can be problematic for samples received on weekends. This limitation of flow cytometry is even more pronounced in developing nations. For all these reasons, the possibility still exists that a patient will have his induction therapy delayed for some time, or in critical situations, that the choice of therapy will be based solely on the morphologic impression of the hematopathologist reviewing the case under the microscope.

Morphologic features of blasts belonging to each of the three main sub-types of acute leukemias have already been well documented, and include the presence or absence of Auer rods and cytoplasmic granules, the cellular size, the abundance of cytoplasm, and the number of nucleoli among others. Although human evaluation of these morphologic features was the standard of care for many decades before the advent of flow cytometry, it is now appreciated that this approach is not as accurate and reproducible as once thought, and that is concerning especially in cases of such a serious medical condition as acute leukemia. For certain sub-types of acute leukemias this challenge is even more pronounced, such as cases of ALL with morphologic features of the previous Franco-American-British (FAB) L2 classification, which even expert hematopathologists will find very difficult to discern from AML (mainly from cases morphologically consistent with the previous FAB M0, M1 and M5a classifications). Furthermore, it is often the case that institutions which do not have in-house flow cytometry most likely will not have staff hematopathologists either, and thus the morphologic diagnosis often is a responsibility of a general pathologist without expertise in leukemia diagnosis.

Hence, although acute leukemia analysis systems and methods are currently available and provide real benefits to patients in need thereof, many advances may still be made to provide improved devices and methods for assessing or predicting an acute leukemic state in an individual. For example, some current analysis systems are prohibitively expensive or do not provide results within a clinically useful timeframe. Relatedly, in some cases, existing techniques may not be readily available in routine laboratories, particularly in developing nations, so that in emergency situations patients may still receive an induction regimen which is chosen based on morphologic analysis and subject to the important limitations mentioned above, or in other cases the start of therapy may be delayed for several days until flow cytometry results are available. Embodiments of the present invention provide solutions that address these problems, and hence provide answers to at least some of these outstanding needs.

### BRIEF SUMMARY OF THE INVENTION

Embodiments of the present invention provide improved techniques for predicting an acute leukemic state or sub-type in an individual that has been diagnosed generally with acute leukemia. By employing the techniques disclosed herein, hematopathologists and clinicians can better predict disease prognosis for each individual patient, assess the likelihood of future complications, and quickly and accurately tailor the induction therapy offered to the acute leukemic patient.

Generally, acute leukemia involves the cancerous growth of immature blood cells. Early detection and treatment is important to prevent the spread of malignancy from the bone marrow into the blood system and other organs of the body. Acute leukemia may occur in various forms. Any of a variety of known techniques can be used to determine whether an individual has acute leukemia. When it comes to choosing the initial drug regimen for induction therapy when a patient is newly diagnosed, it is helpful for clinicians to know to which one of three major types of acute leukemia a case belongs to: acute myeloid leukemia (AML), acute lymphoblastic leukemia (ALL), or acute promyelocytic leukemia (APL).

Embodiments of the present invention provide quick and accurate acute leukemic discrimination results. Using the approaches disclosed herein, it is possible to evaluate blast morphology and predict their lineage, using information obtained from a multi-parametric cellular analysis system. As disclosed herein, exemplary cellular analysis systems can simultaneously measure parameters such as volume, conductivity, and/or multiple angles of light scatter. Such systems provide a high degree of resolution and sensitivity for implementing cellular analysis techniques. In some instances, cellular analysis systems detect light scatter at three, four, five, or more angular ranges. Additionally, cellular analysis systems also can detect signals at an angle between 0° to about 1° from the incident light, which corresponds to a light extinction parameter known as axial light loss. As a non-limiting example, Beckman Coulter's UniCel® DxH™ 800 Cellular Analysis System provides light scatter detection data for multiple angles (e.g. between 0°-0.5° for AL2, about 5.1° for LALS, between 9°-19° for LMALS, and between 20°-43° for UMALS). These techniques allow for fast, accurate diagnosis and treatment of patients newly diagnosed with acute leukemias, particularly in situations where more modern tests such as flow cytometry are not readily available. The performance of this these techniques (e.g. with 100% sensitivity and 100% specificity) are particularly useful for the identification of acute promyelocytic leukemia, a hematological emergency.

Such hematology analysis instruments can evaluate more than 8,000 cells in a matter of seconds, and the morphologic features of cellular volume, cytoplasmic granularity, nuclear complexity, and internal density can be evaluated quantitatively, for example via a point system which can be referred to as cell population data. Numerical decision rules can be generated and used to implement screening strategies for predicting acute leukemic states in an individual.

Hence, embodiments of the present invention encompass systems and methods for the diagnosis of acute leukemia using multiparametric models for disease classification. Patterns of morphological change can be analyzed by combining information from various measured parameters. What is more, by using ratios of parameters, instead of or in addition to the raw values of the parameters themselves, it is possible to introduce internal controls into data sets. Such control techniques can be particularly useful from the laboratory point of view, as it can provide an enhancement of calibration and quality control for cellular analysis systems.

All features of the described systems are applicable to the described methods mutatis mutandis, and vice versa.

In one aspect, embodiments of the present invention encompass automated systems and methods for predicting an acute leukemia sub-type of an individual based on a biological sample obtained from blood of the individual. In some embodiments, the individual may be diagnosed with acute leukemia prior to making the prediction. Exemplary systems include an optical element having a cell interrogation zone, a flow path configured to deliver a hydrodynamically focused stream of the biological sample toward the cell interrogation zone, an electrode assembly configured to measure direct current (DC) impedance and radiofrequency (RF) conductivity of cells of the biological sample passing individually through the cell interrogation zone, a light source oriented to direct a light beam along a beam axis to irradiate the cells of the biological sample individually passing through the cell interrogation zone, and a light detection assembly optically coupled to the cell interrogation zone so as to measure light scattered by and transmitted through the irradiated cells of the biological sample. According to some embodiments, the light detection assembly is configured to measure a first propagated light from the irradiated cells within a first range of angles relative to the light beam axis, a second propagated light from the irradiated cells within a second range of angles relative to the light beam axis, the second range being different than the first range, and an axial light propagated from the irradiated cells along the beam axis. In some cases, systems are configured to correlate a subset of DC impedance, RF conductivity, the first propagated light, the second propagated light, and the axial light measurements from the cells of the biological sample with an acute leukemic sub-type of the individual. Relatedly, exemplary methods for predicting an acute leukemia sub-type of an individual based on a biological sample obtained from blood of the individual may include delivering a hydrodynamically focused stream of the biological sample toward a cell interrogation zone of an optical element, measuring, with an electrode assembly, current (DC) impedance and radiofrequency (RF) conductivity of cells of the biological sample passing individually through the cell interrogation zone, irradiating, with a light beam having an axis, cells of the biological sample individually passing through the cell interrogation zone, measuring, with a light detection assembly, a first propagated light from the irradiated cells within a first range of angles relative to the beam axis, measuring, with the light detection assembly, a second propagated light from the irradiated cells within a second range of angles relative to the beam axis, the second range being different than the first range, measuring, with the light detection assembly, axial light propagated from the irradiated cells along the beam axis, and correlating a subset of DC impedance, RF conductivity, the first propagated light, the second propagated light, and the axial light measurements from the cells of the biological sample with a predicted acute leukemic sub-type of the individual. According to some systems and methods, the light detection assembly includes a first sensor zone that measures the first propagated light, a second sensor zone that measures the second propagated light, and a third sensor zone that measures the axial propagated light. According to some systems and methods, the light detection assembly includes a first sensor that measures the first propagated light, a second sensor that measures the second propagated light, and a third sensor that measures the axial propagated light. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia. According to some systems and methods, acute lymphoblastic leukemia is predicted based upon at least one, up to all, of the parameters listed in Table 4, optionally applying the ranges listed in Table 4. According to some systems and methods, acute promyelocytic leukemia is predicted based upon at least one, up to all, of the parameters listed in Table 5, optionally applying the ranges listed in Table 5.

In one aspect, embodiments of the present invention include automated systems and related methods for predicting an acute leukemia sub-type of an individual diagnosed with acute leukemia based on a biological sample obtained from blood of the individual, where systems include an optical element having a cell interrogation zone, a flow path configured to deliver a hydrodynamically focused stream of the biological sample toward the cell interrogation zone, an electrode assembly configured to measure direct current (DC) impedance and radiofrequency (RF) conductivity of cells of the biological sample passing individually through the cell interrogation zone, a light source oriented to direct a light beam along a beam axis to irradiate the cells of the biological sample individually passing through the cell interrogation zone, and a light detection assembly optically coupled to the cell interrogation zone. In exemplary systems, the light detection assembly can include a first sensor region disposed at a first location relative to the cell interrogation zone that detects a first propagated light, a second sensor region disposed at a second location relative to the cell interrogation zone that detects a second propagated light, and a third sensor region disposed at a third location relative to the cell interrogation zone that detects an axial propagated light. According to some embodiments, the system can be configured to correlate a subset of DC impedance, RF conductivity, the first propagated light, the second propagated light, and the axial light measurements from the cells of the biological sample with an acute leukemic sub-type of the individual. Related systems may be further defined by features of other embodiments disclosed elsewhere herein.

In another aspect, embodiments of the present invention encompass automated systems and methods for predicting an acute leukemia sub-type of an individual. Exemplary systems may include a processor, and a storage medium having a computer application that, when executed by the processor, is configured to cause the system to access cell population data concerning a biological sample of the individual, use the cell population data to determine a predicted sub-type of an acute leukemia of the individual, and output from the processor information relating to the predicted sub-type of the leukemia. Related methods can include accessing cell population data concerning a biological sample of the individual by executing, with a processor, a storage medium comprising a computer application, using the cell population data to determine a predicted sub-type of an acute leukemia of the individual by executing, with the processor, the storage medium, and outputting from the processor information relating to the predicted sub-type of the leukemia. According to some system and method embodiments, the processor is configured to receive the cell population data as input. According to some system and method embodiments, the processor, the storage medium, or both, are incorporated within a hematology machine. According to some system and method embodiments, the processor, the storage medium, or both, are incorporated within a computer, and the computer is in communication with a hematology machine. According to some system and method embodiments, the processor, the storage medium, or both, are incorporated within a computer, and the computer is in remote communication with a hematology machine via a network. According to some system and method embodiments, the hematology machine generates the cell population data. According to some system and method embodiments, the cell population data includes a member selected from the group consisting of an axial light loss measurement of the sample, a light scatter measurement of the sample, and a current measurement of the biological sample. According to some system and method embodiments, the cell population data is obtained using any of the features of any of the systems or method disclosed herein. According to some system and method embodiments, the hematology machine generates the cell population data using any of the features of any of the systems or methods disclosed herein.

In one aspect, embodiments of the present invention encompass automated systems and methods for predicting an acute leukemia sub-type of an individual diagnosed with acute leukemia based on a biological sample obtained from blood of the individual. Exemplary systems include an optical element having a cell interrogation zone, a flow path configured to deliver a hydrodynamically focused stream of the biological sample toward the cell interrogation zone, an electrode assembly configured to measure direct current (DC) impedance and radiofrequency (RF) conductivity of cells of the biological sample passing individually through the cell interrogation zone, a light source oriented to direct a light beam along a beam axis to irradiate the cells of the biological sample individually passing through the cell interrogation zone, and a light detection assembly optically coupled to the cell interrogation zone so as to measure light scattered by and transmitted through the irradiated cells of the biological sample. The light detection assembly may be configured to measure a first propagated light from the irradiated cells within a first range of relative to the light beam axis, a second propagated light from the irradiated cells within a second range of angles relative to the light beam axis, the second range being different than the first range, and an axial light propagated from the irradiated cells along the beam axis. The system may be configured to correlate a subset of DC impedance, RF conductivity, the first propagated light, the second propagated light, and the axial light measurements from the cells of the biological sample with an acute leukemic sub-type of the individual. In some instances, the light detection assembly includes a first sensor zone that measures the first propagated light, a second sensor zone that measures the second propagated light, and a third sensor zone that measures the axial propagated light. In some instances, the light detection assembly may include a first sensor that measures the first propagated light, a second sensor that measures the second propagated light, and a third sensor that measures the axial propagated light. In some instances, the subset may include DC impedance measurements for lymphocytes, monocytes, eosinophils, and non-nucleated red blood cells of the biological sample. In some instances, the subset may include RF conductivity, ALL, LALS, UMALS, and LMALS measurements for neutrophils of the biological sample. In some instances, the subset may include a neutrophil measurement, a monocyte measurement, an eosinophil measurement, a non-nucleated red blood cell measurement, or a combination of two or more thereof, and the acute leukemic sub-type may be acute lymphoblastic leukemia (ALL).

In some instances, the subset may include a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof. In some instances, the subset may include a neutrophil calculated parameter, a monocyte calculated parameter, an eosinophil calculated parameter, a non-nucleated red blood cell calculated parameter, or a combination of two or more thereof, and the acute leukemic sub-type may be acute lymphoblastic leukemia (ALL). In some instances, the subset may include a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. In some instances, the subset may include a calculated parameter based on a function of at least two neutrophil measurements. In some instances, the at least two neutrophil measurements may be selected from the group consisting of a neutrophil upper median angle light scatter measurement, a neutrophil median angle light scatter measurement, and a neutrophil lower median angle light scatter measurement. In some instances, the neutrophil calculated parameter may be is based on a ratio of a neutrophil upper median angle light scatter measurement to a neutrophil median angle light scatter measurement, and the neutrophil median angle light scatter measurement includes the sum of the neutrophil upper median angle light scatter measurement and a neutrophil lower median angle light scatter measurement. In some instances, the subset includes a calculated parameter based on a function of at least two monocyte measurements. In some instances, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement.

In some instances, the monocyte calculated parameter includes a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, or a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. In some instances, the subset includes a calculated parameter based on a function of at least two eosinophil measurements. In some instances, the at least two eosinophil measurements are selected from the group consisting of an eosinophil lower median angle light scatter measurement, an eosinophil median angle light scatter measurement, and an eosinophil upper median angle light scatter measurement. In some instances, the eosinophil calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. In some instances, the subset includes a calculated parameter based on a function of at least two non-nucleated red blood cell measurements. In some instances, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement. In some instances, the non-nucleated red blood cell calculated parameter includes a member selected from the group consisting of a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement. The non-nucleated red blood cell median angle light scatter measurement may include the sum of a non-nucleated red blood cell upper median angle light scatter measurement and the non-nucleated red blood cell lower median angle light scatter measurement. In some instances, the subset includes a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL). In some instances, the subset includes a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof.

According to some embodiments, the subset may include a neutrophil calculated parameter, a lymphocyte calculated parameter, an eosinophil calculated parameter, a non-nucleated red blood cell calculated parameter, or a combination of two or more thereof, and the acute leukemic sub-type may be acute promyelocytic leukemia (APL). In some instances, the neutrophil calculated parameter includes a ratio of a neutrophil high frequency current measurement to a neutrophil axial light loss measurement. In some instances, the lymphocyte calculated parameter includes a ratio of a lymphocyte lower median angle light scatter measurement to a lymphocyte mean median angle light scatter measurement. In some instances, the eosinophil calculated parameter includes a ratio of an eosinophil lower median angle light scatter measurement to a eosinophil axial light loss measurement. In some instances, the non-nucleated red blood cell calculated parameter includes a ratio of a non-nucleated red blood cell low angle light scatter measurement to a non-nucleated red blood cell low frequency current measurement.

In some instances, the biological sample comprises a blood sample of the individual. In some instances, the biological sample includes neutrophils, lymphocytes, monocytes, eosinophils, and non-nucleated red blood cells (or leukocytes or WBCs) of the individual. In some instances, the acute leukemic sub-type includes a member selected from the group consisting of an acute lymphoblastic leukemia sub-type, an acute promyelocytic leukemia sub-type, and an acute myeloid leukemia sub-type.

In another aspect, embodiments of the present invention encompass methods for predicting an acute leukemia sub-type of an individual based on a biological sample obtained from blood of the individual. Exemplary methods may include delivering a hydrodynamically focused stream of the biological sample toward a cell interrogation zone of an optical element, measuring, with an electrode assembly, current (DC) impedance and radiofrequency (RF) conductivity of cells of the biological sample passing individually through the cell interrogation zone, irradiating, with an electromagnetic beam having an axis, cells of the biological sample individually passing through the cell interrogation zone, measuring, with a light detection assembly, a first propagated light from the irradiated cells within a first range of relative to the beam axis, measuring, with the light detection assembly, a second propagated light from the irradiated cells within a second range of angles relative to the beam axis, the second range being different than the first range, measuring, with the light detection assembly, axial light propagated from the irradiated cells along the beam axis, and correlating a subset of DC impedance, RF conductivity, the first propagated light, the second propagated light, and the axial light measurements from the cells of the biological sample with a predicted acute leukemic sub-type of the individual. In some instances, the subset includes a calculated parameter, the calculated parameter is based on a function of at least two measures of cell population data, and the acute leukemic sub-type is assigned based at least in part on the calculated parameter. In some instances, the predicted acute leukemic sub-type includes a member selected from the group consisting of an acute lymphoblastic leukemia indication, an acute promyelocytic leukemia indication, and an acute myeloid leukemia indication. In some instances, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). In some instances, the neutrophil calculated parameter is based on a ratio of a neutrophil upper median angle light scatter parameter to a neutrophil median angle light scatter parameter, and the neutrophil median angle light scatter parameter includes the sum of the neutrophil upper median angle light scatter parameter and a neutrophil lower median angle light scatter parameter. In some instances, the monocyte calculated parameter includes a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter comprising the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter comprising the sum of the monocyte upper median angle light scatter parameter and a monocyte lower median angle light scatter parameter, or a ratio of a monocyte lower median angle light scatter parameter to a monocyte median angle light scatter parameter, the monocyte median angle light scatter parameter comprising the sum of a monocyte upper median angle light scatter parameter and the monocyte lower median angle light scatter parameter. In some instances, the eosinophil calculated parameter includes a ratio of an eosinophil lower median angle light scatter parameter to an eosinophil median angle light scatter parameter, the eosinophil median angle light scatter parameter comprising the sum of an eosinophil upper median angle light scatter parameter and the eosinophil lower median angle light scatter parameter. In some instances, the non-nucleated red blood cell calculated parameter includes a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, or a ratio of a non-nucleated red blood cell lower median angle light scatter parameter to a non-nucleated red blood cell median angle light scatter parameter, the non-nucleated red blood cell median angle light scatter parameter comprising the sum of a non-nucleated red blood cell upper median angle light scatter parameter and the non-nucleated red blood cell lower median angle light scatter parameter. In some instances, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). In some instances, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). In some instances, wherein the subset is determined based on a pre-defined specificity for acute leukemia. In some instances, the subset is determined based on a pre-defined sensitivity for acute leukemia. In some instances, the subset includes a calculated parameter for identifying acute lymphoblastic leukemia. In some instances, the subset includes a calculated parameter for identifying acute promyelocyte leukemia.

In another aspect, embodiments of the present invention encompass methods of evaluating a biological sample from an individual. Exemplary methods include obtaining a cell population data profile for the biological sample, assigning an acute leukemia sub-type indication to the biological sample based on the cell population data profile, and outputting the assigned acute leukemia sub-type indication. In some cases, the sub-type indication can be assigned based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In still another aspect, embodiments of the present invention encompass automated systems for predicting an acute leukemia sub-type of an individual based on a biological sample obtained from the individual. Exemplary systems include a conduit configured to receive and direct movement of the biological sample thorough an aperture, a light scatter and absorption measuring device configured to emit light through the biological sample as it moves through the aperture and collect data concerning scatter and absorption of the light, and a current measuring device configured to pass an electric current through the biological sample as it moves through the aperture and collect data concerning the electric current. The system may be configured to correlate the data concerning scatter and absorption of the light and the data concerning the electric current with an acute leukemic sub-type of the individual. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass automated systems for predicting an acute leukemia sub-type of an individual based on a biological sample obtained from the individual. Exemplary systems may include a transducer for obtaining light scatter data, light absorption data, and current data for the biological sample as the sample passes through an aperture, a processor, and a storage medium having a computer application that, when executed by the processor, is configured to cause the system to use the light scatter data, the light absorption data, the current data, or a combination thereof, to determine a predicted sub-type of an acute leukemia of the individual, and to output from the processor information relating to the predicted sub-type of the acute leukemia. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass automated systems for predicting an acute leukemia sub-type of an individual based on a biological sample obtained from the individual. Exemplary systems may include a transducer for obtaining cell population data for the biological sample as the sample passes through an aperture, a processor, and a storage medium having a computer application that, when executed by the processor, is configured to cause the system to use the cell population data to determine a predicted sub-type of acute leukemia of the individual, and to output from the processor information relating to the predicted sub-type of the acute leukemia. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In yet another aspect, embodiments of the present invention encompass automated systems for identifying if an individual may have acute leukemia based on a biological sample obtained from the individual. Exemplary systems may include a transducer for obtaining light scatter data, light absorption data, and current data for the biological sample as the sample passes through an aperture, a processor, and a storage medium having a computer application that, when executed by the processor, is configured to cause the system to use a calculated parameter, which is based on a function of at least two measures of the light scatter data, light absorption data, or current data, to determine a predicted sub-type of an acute leukemia of the individual, and to output from the processor leukemia information relating to the predicted sub-type of the individual. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass methods of evaluating a biological sample obtained from an individual. Exemplary methods may include passing the biological sample through an aperture of a particle analysis system, obtaining light scatter data, light absorption data, and current data for the biological sample as the sample passes through the aperture, determining a cell population data profile for the biological sample based on the light scatter data, the light absorption data, the current data, or a combination thereof, assigning an acute leukemia sub-type indication to the biological sample based on the cell population data profile, and outputting the assigned acute leukemia sub-type indication. In some cases, the sub-type indication can be assigned based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In yet another aspect, embodiments of the present invention encompass automated methods of evaluating a biological sample from an individual. Exemplary methods may include obtaining, using a particle analysis system, light scatter data, light absorption data, and current data for the biological sample as the sample passes through an aperture, determining a cell population data profile for the biological sample based on assay results obtained from the particle analysis system, determining, using a computer system, an acute leukemia sub-type physiological status for the individual according to a calculated parameter, where the calculated parameter is based on a function of at least two cell population data measures of the cell population data profile, and outputting the acute leukemia sub-type physiological status. In some cases, the sub-type indication can be determined based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass automated systems for predicting an acute leukemia sub-type of an individual. Exemplary systems may include a processor, and a storage medium comprising a computer application that, when executed by the processor, is configured to cause the system to access information concerning a biological sample of the individual, including information relating at least in part to an axial light loss measurement of the sample, a light scatter measurement of the sample, a current measurement of the sample, or a combination of two or more thereof, to use the information relating at least in part to the axial light loss measurement, the plurality of light scatter measurements, the current measurement, or the combination thereof, to determine a predicted sub-type of an acute leukemia of the individual, and to output from the processor information relating to the predicted sub-type of the acute leukemia. In some instances, the current measurement includes a low frequency current measurement of the sample, a high frequency current measurement of the sample, or a combination thereof. In some instances, the light scatter measurement includes a low angle light scatter measurement, a lower median angle light scatter measurement, an upper median angle light scatter measurement, or a combination of two or more thereof. In some instances, a system may also include an electromagnetic beam source and a photosensor assembly, where the photosensor assembly is used to obtain the axial light loss measurement. In some instances, a system may also include an electromagnetic beam source and a photosensor assembly, where the photosensor assembly is used to obtain the light scatter measurement. In some instances, a system may also include an electromagnetic beam source and an electrode assembly, where the electrode assembly is used to obtain the current measurement. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass an automated system for predicting an acute leukemia sub-type of an individual. Exemplary systems may include a processor, and a storage medium having a computer application that, when executed by the processor, is configured to cause the system to access cell population data concerning a biological sample of the individual, to use the cell population data to determine a predicted sub-type of an acute leukemia of the individual, and to output from the processor information relating to the predicted sub-type of the leukemia. In some instances, the processor is configured to receive the cell population data as input. In some instances, the processor, the storage medium, or both, are incorporated within a hematology machine. In some instances, the hematology machine generates the cell population data. In some instances, the processor, the storage medium, or both, are incorporated within a computer, and the computer is in communication with a hematology machine. In some instances, the hematology machine generates the cell population data. In some instances, the processor, the storage medium, or both, are incorporated within a computer, and the computer is in remote communication with a hematology machine via a network. In some instances, the hematology machine generates the cell population data. In some instances, the cell population data includes a member selected from the group consisting of an axial light loss measurement of the sample, a light scatter measurement of the sample, and a current measurement of the sample. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In still yet another aspect, embodiments of the present invention encompass automated systems for evaluating the physiological status of an individual. Exemplary systems may include a processor, and a storage medium having a computer application that, when executed by the processor, is configured to cause the system to access cell population data concerning a biological sample of the individual, to use a calculated parameter, which is based on function of at least two measures of the cell population data, to determine the physiological status of the individual, the determined physiological status providing an indication whether the individual has an acute leukemia sub-type, and to output from the processor information relating to the physiological status of the individual. In some cases, the sub-type indication can be based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass automated systems for identifying if an individual may have an acute leukemia sub-type from hematology system data. Exemplary systems may include a processor, and a storage medium having a computer application that, when executed by the processor, is configured to cause the system to access hematology cell population data concerning a blood sample of the individual, to use a calculated parameter, which is based on a function of at least two measures of the hematology cell population data, to determine a predicted sub-type of an acute leukemia of the individual, and to output from the processor leukemia information relating to the predicted sub-type of the individual. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In still another aspect, embodiments of the present invention encompass automated methods of evaluating a biological sample from an individual. Exemplary methods may include determining a cell population data profile for the biological sample based on assay results obtained from a particle analysis system analyzing the sample, determining, using a computer system, a physiological status for the individual according to a calculated parameter, where the calculated parameter is based on a function of at least two cell population data measures of the cell population data profile, and where the physiological status provides an indication whether the individual has an acute leukemia sub-type, and outputting the physiological status. In some cases, the sub-type indication can be provided based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass methods of determining an induction regimen for an acute leukemia patient. Exemplary methods may include accessing a cell population data profile concerning a biological sample of the patient, determining, using a computer system, a predicted sub-type of acute leukemia for the patient based on the cell population data profile, and determining the induction regimen for the patient based on the predicted sub-type of acute leukemia. In some instances, the predicted sub-type of acute leukemia includes a member selected from the group consisting of an acute lymphoblastic leukemia indication, an acute promyelocytic leukemia indication, and an acute myeloid leukemia indication. In some instances, the step of determining the predicted sub-type of acute leukemia includes using a calculated parameter, and the calculated parameter is based on a function of at least two cell population data measures. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In another aspect, embodiments of the present invention encompass methods of determining a treatment regimen for an individual. Exemplary methods may include accessing a cell population data profile concerning a biological sample of the individual, determining, using a computer system, a physiological status for the individual according to a calculated parameter, where the calculated parameter is based on a function of at least two cell population data measures of the cell population data profile, and where the physiological status corresponds to an acute leukemia sub-type, and determining the treatment regimen for the individual based on the a physiological status for the individual. In some cases, the sub-type indication can be determined based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

In yet another aspect, embodiments of the present invention encompass automated systems for predicting an acute leukemia sub-type of an individual diagnosed with acute leukemia based on a biological sample obtained from blood of the individual. Exemplary systems may include an optical element having a cell interrogation zone, a flow path configured to deliver a hydrodynamically focused stream of the biological sample toward the cell interrogation zone, an electrode assembly configured to measure direct current (DC) impedance and radiofrequency (RF) conductivity of cells of the biological sample passing individually through the cell interrogation zone, a light source oriented to direct a light beam along a beam axis to irradiate the cells of the biological sample individually passing through the cell interrogation zone, and a light detection assembly optically coupled to the cell interrogation zone. The light detection assembly may include a first sensor region disposed at a first location relative to the cell interrogation zone that detects a first propagated light, a second sensor region disposed at a second location relative to the cell interrogation zone that detects a second propagated light, and a third sensor region disposed at a third location relative to the cell interrogation zone that detects an axial propagated light. The system may be configured to correlate a subset of DC impedance, RF conductivity, the first propagated light, the second propagated light, and the axial light measurements from the cells of the biological sample with an acute leukemic sub-type of the individual. In some cases, the sub-type indication can be predicted based on a subset of DC impedance, RF conductivity, the first propagated light, the second propagated light, and the axial light measurements from the cells of the biological sample. According to some systems and methods, the subset includes DC impedance measurements for lymphocytes, monocytes, eosinophils, and non-nucleated red blood cells of the biological sample; RF conductivity, ALL, LALS, UMALS, and LMALS measurements for neutrophils of the biological sample; a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL); a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof; a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample. According to some systems and methods, the subset includes a calculated parameter based on a function of at least two neutrophil measurements. According to some systems and methods, the at least two neutrophil measurements are selected from the group consisting of a neutrophil upper median angle light scatter measurement, a neutrophil median angle light scatter measurement, and a neutrophil lower median angle light scatter measurement; or the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement. According to some systems and methods, the subset includes a calculated parameter based on a function of at least two monocyte measurements. According to some systems and methods, the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or the calculated parameter comprises a member selected from the group consisting of: a ratio of a monocyte high frequency current measurement to a monocyte low frequency current measurement, a ratio of a monocyte low angle light scatter measurement to a monocyte axial light loss measurement, a ratio of a monocyte low frequency current measurement to a monocyte axial light loss measurement, a ratio of a monocyte upper median angle light scatter measurement to a monocyte low frequency current measurement, a ratio of a monocyte low angle light scatter measurement to a monocyte low frequency current measurement, a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement, a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement. According to some systems and methods, the subset includes a calculated parameter based on a function of at least two eosinophil measurements. According to some systems and methods, the at least two eosinophil measurements are selected from the group consisting of an eosinophil lower median angle light scatter measurement, an eosinophil median angle light scatter measurement, and an eosinophil upper median angle light scatter measurement; or the calculated parameter includes a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement. According to some systems and methods, the subset includes a calculated parameter based on a function of at least two non-nucleated red blood cell measurements. According to some systems and methods, the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or the calculated parameter includes a member selected from the group consisting of: a ratio of a non-nucleated red blood cell lower median angle light scatter measurement to a non-nucleated red blood cell axial light loss measurement, a ratio of a non-nucleated red blood cell low angle light scatter measurement to a non-nucleated red blood cell axial light loss measurement, and a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement. According to some systems and methods, the subset includes: a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof. According to some systems and methods, the subset includes a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL). According to some systems and methods, the neutrophil calculated parameter includes a ratio of a neutrophil high frequency current measurement to a neutrophil axial light loss measurement; the lymphocyte calculated parameter includes a ratio of a lymphocyte lower median angle light scatter measurement to a lymphocyte mean median angle light scatter measurement; the eosinophil calculated parameter includes a ratio of an eosinophil lower median angle light scatter measurement to a eosinophil axial light loss measurement; or the non-nucleated red blood cell calculated parameter includes a ratio of a non-nucleated red blood cell low angle light scatter measurement to a non-nucleated red blood cell low frequency current measurement. According to some systems and methods, the biological sample includes a blood sample of the individual, or neutrophils, lymphocytes, monocytes, eosinophils, and non-nucleated red blood cells of the individual. According to some systems and methods, the acute leukemic sub-type includes a member selected from the group consisting of an acute lymphoblastic leukemia sub-type or indication, an acute promyelocytic leukemia sub-type or indication, and an acute myeloid leukemia sub-type or indication. According to some systems and methods, the subset includes a calculated parameter, wherein the calculated parameter is based on a function of at least two measures of cell population data, and wherein the acute leukemic sub-type is assigned based at least in part on the calculated parameter. According to some systems and methods, the predicted acute leukemic sub-type is an acute lymphoblastic leukemia indication, and the subset includes a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute lymphoblastic leukemia indication, and the subset includes a neutrophil calculated parameter (NE), a monocyte calculated parameter (MO), an eosinophil calculated parameter (EO), and a non-nucleated red blood cell calculated parameter (NNRBC). According to some systems and methods, the neutrophil calculated parameter is based on a ratio of a neutrophil upper median angle light scatter parameter to a neutrophil median angle light scatter parameter, the neutrophil median angle light scatter parameter including the sum of the neutrophil upper median angle light scatter parameter and a neutrophil lower median angle light scatter parameter; and/or the monocyte calculated parameter includes a member selected from the group consisting of: a ratio of a monocyte conductivity parameter to a monocyte volume parameter, a ratio of a monocyte low angle light scatter parameter to a monocyte axial light loss parameter, a ratio of a monocyte volume parameter to a monocyte axial light loss parameter, a ratio of a monocyte upper median angle light scatter to a monocyte volume parameter, a ratio of a monocyte low angle light scatter parameter to a monocyte volume parameter, a ratio of a monocyte low angle light scatter parameter to a monocyte median angle light scatter parameter, the monocyte median angle light scatter parameter including the sum of a monocyte upper median angle light scatter parameter and a monocyte lower median angle light scatter parameter, a ratio of a monocyte upper median angle light scatter parameter to a monocyte median angle light scatter parameter, the monocyte median angle light scatter parameter including the sum of the monocyte upper median angle light scatter parameter and a monocyte lower median angle light scatter parameter, and a ratio of a monocyte lower median angle light scatter parameter to a monocyte median angle light scatter parameter, the monocyte median angle light scatter parameter including the sum of a monocyte upper median angle light scatter parameter and the monocyte lower median angle light scatter parameter; and/or the eosinophil calculated parameter includes a ratio of an eosinophil lower median angle light scatter parameter to an eosinophil median angle light scatter parameter, the eosinophil median angle light scatter parameter including the sum of an eosinophil upper median angle light scatter parameter and the eosinophil lower median angle light scatter parameter; and/or the non-nucleated red blood cell calculated parameter includes a member selected from the group consisting of: a ratio of a non-nucleated red blood cell lower median angle light scatter parameter to a non-nucleated red blood cell axial light loss parameter, a ratio of a non-nucleated red blood cell low angle light scatter parameter to a non-nucleated red blood cell axial light loss parameter, and a ratio of a non-nucleated red blood cell lower median angle light scatter parameter to a non-nucleated red blood cell median angle light scatter parameter, the non-nucleated red blood cell median angle light scatter parameter including the sum of a non-nucleated red blood cell upper median angle light scatter parameter and the non-nucleated red blood cell lower median angle light scatter parameter. According to some systems and methods, the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2). According to some systems and methods, the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC). According to some systems and methods, the subset is determined based on a pre-defined specificity and/or sensitivity for acute leukemia. According to some systems and methods, the subset includes a calculated parameter for identifying acute lymphoblastic leukemia or a calculated parameter for identifying acute promyelocyte leukemia.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this Summary. This Summary is a high-level overview of various aspects of the invention and introduces some of the concepts that are further described in the Detailed Description section below. This Summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The above described and many other features and attendant advantages of embodiments of the present invention will become apparent and further understood by reference to the following detailed description when considered in conjunction with the accompanying drawings.

### BRIEF DESCRIPTION OF THE DRAWINGS

FIG. 1 provides a schematic diagram of hematopoiesis cell differentiation events which occur in the human blood marrow, according to embodiments of the present invention.

FIG. 2 schematically depicts aspects of a cellular analysis system, according to embodiments of the present invention.

FIG. 3 provides a system block diagram illustrating aspects of a cellular analysis system according to embodiments of the present invention.

FIG. 4 illustrates aspects of an automated cellular analysis system for predicting an acute leukemia state of an individual, according to embodiments of the present invention.

FIG. 4A shows aspects of an optical element of a cellular analysis system, according to embodiments of the present invention.

FIG. 5 depicts aspects of an exemplary method for predicting an acute leukemic state of an individual, according to embodiments of the present invention.

FIG. 6 provides a simplified block diagram of an exemplary module system, according to embodiments of the present invention.

FIG. 7 depicts an exemplary screen shot of a differential count screen, according to embodiments of the present invention.

FIG. 7A schematically shows a technique for obtaining CPD parameters, according to embodiments of the present invention.

FIG. 8 illustrates aspects of a method for obtaining and using a decision rule, according to embodiments of the present invention.

FIGS. 9A (i-iii), 9B (i-iii), 9C (i-iii), 9D (i-iiii), 9E (i-ii), and 9F (i-iiii) depict aspects of a process for determining effective parameters for a decision rule, according to embodiments of the present invention.

### DETAILED DESCRIPTION OF THE INVENTION

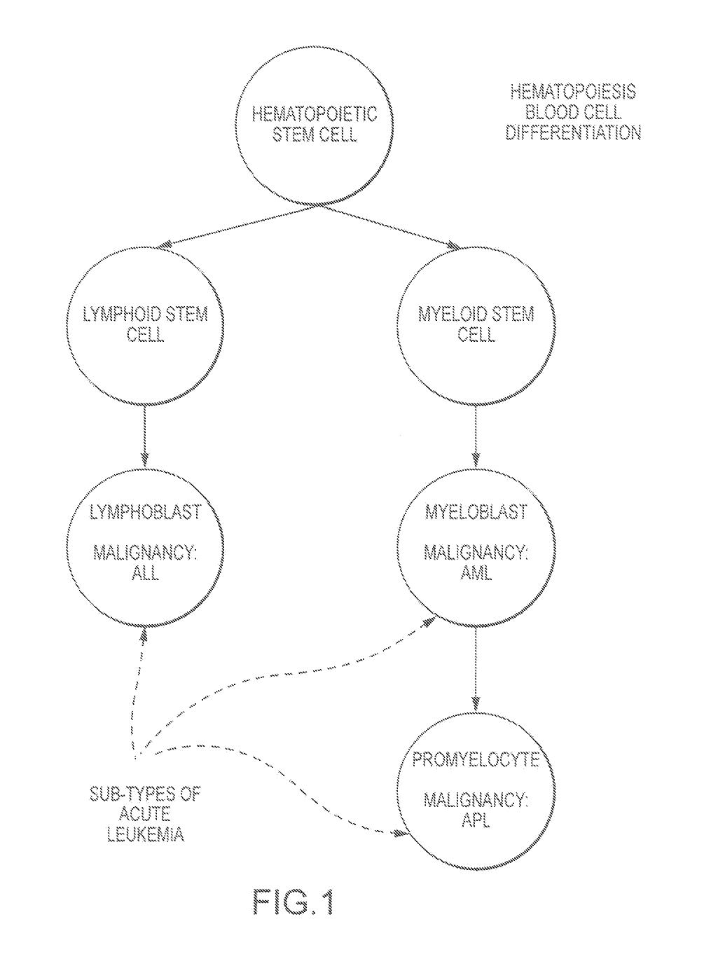

Described herein are hematology systems and methods configured to predict an acute leukemic state or sub-type of an individual diagnosed with acute leukemia, based on a biological sample obtained from the individual. FIG. 1 provides a schematic diagram of hematopoiesis cell differentiation events which occur in the human blood marrow. As shown here, a multipotential or pluripotential hematopoietic stem cell can give rise to either lymphoid stem cells (common lymphoid progenitor) or myeloid stem cells (common myeloid progenitor). In turn, lymphoblasts derive from the lymphoid stem cells. In acute lymphoblastic leukemia (ALL), there is unregulated growth in the bone marrow of the lymphoblasts. Similarly, myeloblasts derive from the myeloid stem cells. In acute myeloid or myelogenous leukemia (AML), there is unregulated growth in the bone marrow of this myeloid line of blood cells. As further depicted here, myeloblasts can differentiate into promyelocytes (progranulocytes). Acute promyelocytic or progranulocytic leukemia (APL) is a subtype of AML, characterized by a malignant accumulation of promyelocytes. The hematology systems and methods discussed herein can predict such acute leukemic states or sub-types based on data related to certain impedance, conductivity, and angular light propagation measurements of a biological sample of an individual that has been diagnosed with acute leukemia.

Cellular analysis systems that detect light scatter at multiple angles can be used to analyze a biological sample (e.g. a blood sample) and output a predicted acute leukemia state or sub-type of an individual previously diagnosed with acute leukemia. Exemplary systems are equipped with sensor assemblies that obtain light scatter data for three or more angular ranges, in addition to light transmission data associated with an extinction or axial light loss measure, and thus provide accurate, sensitive, and high resolution results without requiring the use of certain dye, antibody, or fluorescence techniques. In one instance, a hematology analyzer such as a DxH 800 Hematology Analyzer (Beckman Coulter, Brea, Calif., USA) is configured to analyze a biological sample (e.g. a blood sample) based on multiple light scatter angles and output a predicted acute leukemia state or sub-type of an individual previously diagnosed with acute leukemia. The DxH 800 includes a WBC channel processing module that is configured to recognize the morphologic features indicative of the main sub-types of White Blood Cells (WBCs) and generate a differential count. Specifically, there are five types of leukocytes (white blood cells). A leukocyte differential count, or WBC differential, indicates the relative proportion of each of the cell types in a biological sample. A WBC differential typically includes counts or percentages for neutrophils, lymphocytes, monocytes, eosinophils, and basophils. Relatedly, the DxH includes an nRBC channel processing module that is configured to analyze leukocytes. The DxH 800 is also configured to generate a significant amount of additional data based on analysis of the sample, this additional data, which is described in more detail below, is referred to as Cell Population Data (CPD).

In some embodiments, the differential count and cell population data is based on the determination of 7 different parameters for each cell of the sample analyzed, such parameters correlating to each cell's morphology. Specifically, a volume parameter corresponding to the cell size can be measured directly by impedance. Further, a conductivity parameter corresponding to the internal cellular density can be measured directly by the conduction of radio frequency waves across the cell. What is more, five different angles (or ranges of angles) of light scatter corresponding to cytoplasmic granularity and nuclear complexity, for example, can be measured with various light detection mechanisms.

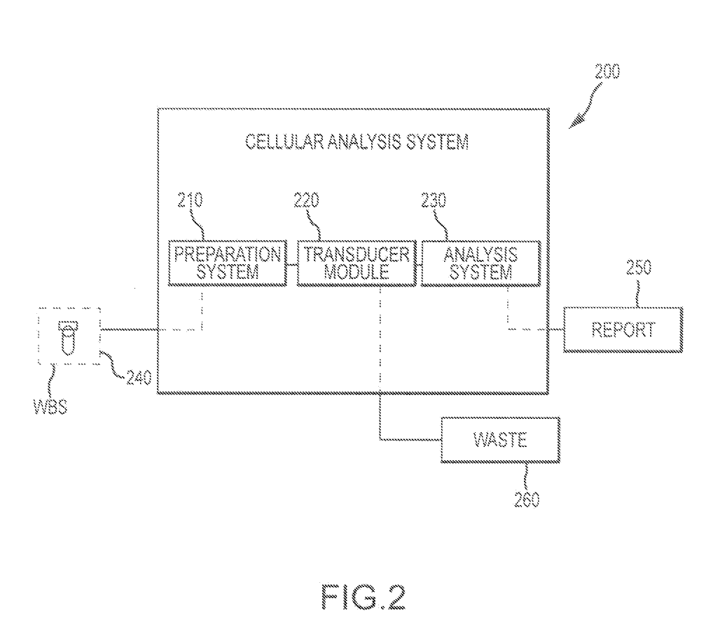

FIG. 2 schematically depicts a cellular analysis system 200. As shown here, system 300 includes a preparation system 210, a transducer module 220, and an analysis system 230. While system 200 is herein described at a very high level, with reference to the three core system blocks (210, 220, and 230), one of skill in the art would readily understand that system 200 includes many other system components such as central control processor(s), display system(s), fluidic system(s), temperature control system(s), user-safety control system(s), and the like. In operation, a whole blood sample (WBS) 240 can be presented to the system 200 for analysis. In some instances, WBS 240 is aspirated into system 200. Exemplary aspiration techniques are known to the skilled artisan. After aspiration, WBS 240 can be delivered to a preparation system 210. Preparation system 210 receives WBS 240 and can perform operations involved with preparing WBS 240 for further measurement and analysis. For example, preparation system 210 may separate WBS 240 into predefined aliquots for presentation to transducer module 220. Preparation system 210 may also include mixing chambers so that appropriate reagents may be added to the aliquots. For example, where an aliquot is to be tested for differentiation of white blood cell subset populations, a lysing reagent (e.g. ERYTHROLYSE, a red blood cell lysing buffer) may be added to the aliquot to break up and remove the RBCs. Preparation system 210 may also include temperature control components to control the temperature of the reagents and/or mixing chambers. Appropriate temperature controls can improve the consistency of the operations of preparation system 210.

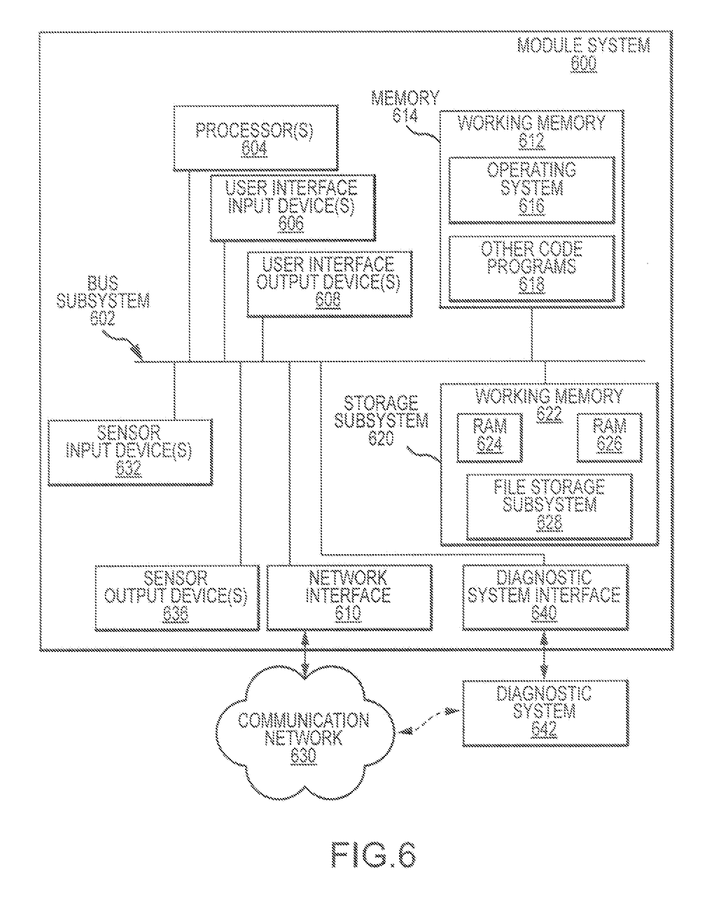

In some instances, predefined aliquots can be transferred from preparation system 210 to transducer module 220. As described in further detail below, transducer module 220 can perform direct current (DC) impedance, radiofrequency (RF) conductivity, light transmission, and/or light scatter measurements of cells from the WBS passing individually therethrough. Measured DC impedance, RF conductivity, and light propagation (e.g. light transmission, light scatter) parameters can be provided or transmitted to analysis system 230 for data processing. In some instances, analysis system 230 may include computer processing features and/or one or more modules or components such as those described herein with reference to the system depicted in FIG. 6 and described further below, which can evaluate the measured parameters, identify and enumerate the WBS constituents, and correlate a subset of data characterizing elements of the WBS with an acute leukemic state of the individual. As shown here, cellular analysis system 200 may generate or output a report 250 containing the predicted leukemic state and/or a prescribed treatment regimen for the individual. In some instances, excess biological sample from transducer module 220 can be directed to an external (or alternatively internal) waste system 260.

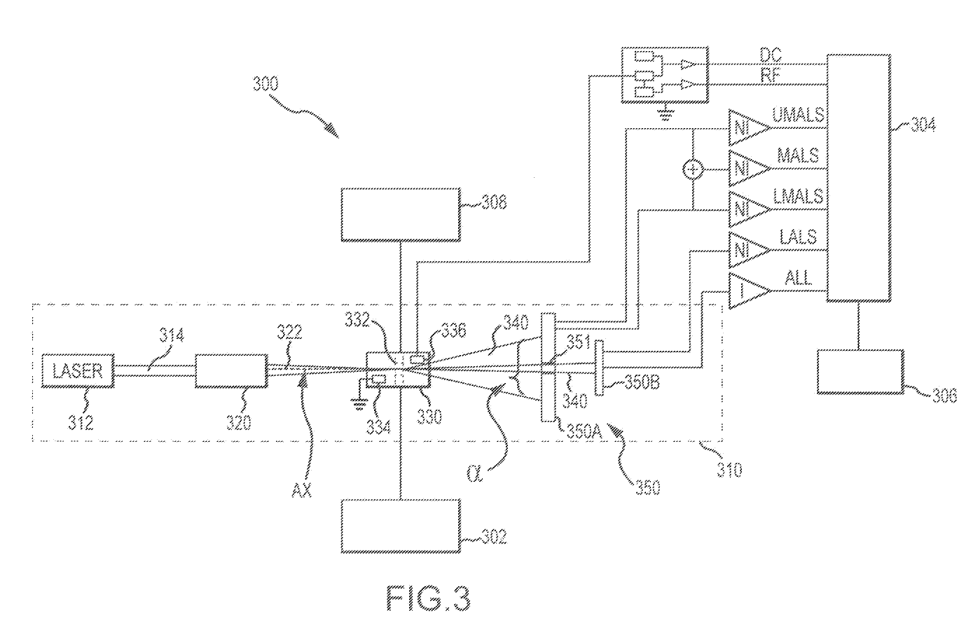

FIG. 3 illustrates in more detail a transducer module and associated components in more detail. As shown here, system 300 includes a transducer module 310 having a light or irradiation source such as a laser 310 emitting a beam 314. The laser 312 can be, for example, a 635 nm, 5 mW, solid-state laser. In some instances, system 300 may include a focus-alignment system 320 that adjusts beam 314 such that a resulting beam 322 is focused and positioned at a cell interrogation zone 332 of a flow cell 330. In some instances, flow cell 330 receives a sample aliquot from a preparation system 302. As described elsewhere herein, various fluidic mechanisms and techniques can be employed for hydrodynamic focusing of the sample aliquot within flow cell 330.

In some instances, the aliquot generally flows through the cell interrogation zone 332 such that its constituents pass through the cell interrogation zone 332 one at a time. In some cases, a system 300 may include a cell interrogation zone or other feature of a transducer module or blood analysis instrument such as those described in U.S. Pat. Nos. 5,125,737; 6,228,652; 7,390,662; 8,094,299; and 8,189,187, the contents of which are incorporated herein by references. For example, a cell interrogation zone 332 may be defined by a square transverse cross-section measuring approximately 50×50 microns, and having a length (measured in the direction of flow) of approximately 65 microns. Flow cell 330 may include an electrode assembly having first and second electrodes 334, 336 for performing DC impedance and RF conductivity measurements of the cells passing through cell interrogation zone 332. Signals from electrodes 334, 336 can be transmitted to analysis system 304. The electrode assembly can analyze volume and conductivity characteristics of the cells using low-frequency current and high-frequency current, respectively. For example, low-frequency DC impedance measurements can be used to analyze the volume of each individual cell passing through the cell interrogation zone. Relatedly, high-frequency RF current measurements can be used to determine the conductivity of cells passing through the cell interrogation zone. Because cell walls act as conductors to high frequency current, the high frequency current can be used to detect differences in the insulating properties of the cell components, as the current passes through the cell walls and through each cell interior. High frequency current can be used to characterize nuclear and granular constituents and the chemical composition of the cell interior.

Incoming beam 322 travels along beam axis AX and irradiates the cells passing through cell interrogation zone 332, resulting in light propagation within an angular range α(e.g. scatter, transmission) emanating from the zone 332. Exemplary systems are equipped with sensor assemblies that can detect light within three, four, five, or more angular ranges within the angular range α, including light associated with an extinction or axial light loss measure as described elsewhere herein. As shown here, light propagation 340 can be detected by a light detection assembly 350, optionally having a light scatter detector unit 350A and a light scatter and transmission detector unit 350B. In some instances, light scatter detector unit 350A includes a photoactive region or sensor zone for detecting and measuring upper median angle light scatter (UMALS), for example light that is scattered or otherwise propagated at angles relative to a light beam axis within a range from about 20 to about 42 degrees. In some instances, UMALS corresponds to light propagated within an angular range from between about 20 to about 43 degrees, relative to the incoming beam axis which irradiates cells flowing through the interrogation zone. Light scatter detector unit 350A may also include a photoactive region or sensor zone for detecting and measuring lower median angle light scatter (LMALS), for example light that is scattered or otherwise propagated at angles relative to a light beam axis within a range from about 10 to about 20 degrees. In some instances, LMALS corresponds to light propagated within an angular range from between about 9 to about 19 degrees, relative to the incoming beam axis which irradiates cells flowing through the interrogation zone.

A combination of UMALS and LMALS is defined as median angle light scatter (MALS), which is light scatter or propagation at angles between about 9 degrees and about 43 degrees relative to the incoming beam axis which irradiates cells flowing through the interrogation zone.

As shown in FIG. 3, the light scatter detector unit 350A may include an opening 351 that allows low angle light scatter or propagation 340 to pass beyond light scatter detector unit 350A and thereby reach and be detected by light scatter and transmission detector unit 350B. According to some embodiments, light scatter and transmission detector unit 350B may include a photoactive region or sensor zone for detecting and measuring lower angle light scatter (LALS), for example light that is scattered or propagated at angles relative to an irradiating light beam axis of about 5.1 degrees. In some instances, LALS corresponds to light propagated at an angle of less than about 9 degrees, relative to the incoming beam axis which irradiates cells flowing through the interrogation zone. In some instances, LALS corresponds to light propagated at an angle of less than about 10 degrees, relative to the incoming beam axis which irradiates cells flowing through the interrogation zone. In some instances, LALS corresponds to light propagated at an angle of about 1.9 degrees±0.5 degrees, relative to the incoming beam axis which irradiates cells flowing through the interrogation zone. In some instances, LALS corresponds to light propagated at an angle of about 3.0 degrees±0.5 degrees, relative to the incoming beam axis which irradiates cells flowing through the interrogation zone. In some instances, LALS corresponds to light propagated at an angle of about 3.7 degrees±0.5 degrees, relative to the incoming beam axis which irradiates cells flowing through the interrogation zone. In some instances, LALS corresponds to light propagated at an angle of about 5.1 degrees±0.5 degrees, relative to the incoming beam axis which irradiates cells flowing through the interrogation zone. In some instances, LALS corresponds to light propagated at an angle of about 7.0 degrees±0.5 degrees, relative to the incoming beam axis which irradiates cells flowing through the interrogation zone.

According to some embodiments, light scatter and transmission detector unit 350B may include a photoactive region or sensor zone for detecting and measuring light transmitted axially through the cells, or propagated from the irradiated cells, at an angle of 0 degrees relative to the incoming light beam axis. In some cases, the photoactive region or sensor zone may detect and measure light propagated axially from cells at angles of less than about 1 degree relative to the incoming light beam axis. In some cases, the photoactive region or sensor zone may detect and measure light propagated axially from cells at angles of less than about 0.5 degrees relative to the incoming light beam axis less. Such axially transmitted or propagated light measurements correspond to axial light loss (ALL or AL2). As noted in previously incorporated U.S. Pat. No. 7,390,662, when light interacts with a particle, some of the incident light changes direction through the scattering process (i.e. light scatter) and part of the light is absorbed by the particles. Both of these processes remove energy from the incident beam. When viewed along the incident axis of the beam, the light loss can be referred to as forward extinction or axial light loss. Additional aspects of axial light loss measurement techniques are described in U.S. Pat. No. 7,390,662 at column 5, line 58 to column 6, line 4.

As such, the cellular analysis system 300 provides means for obtaining light propagation measurements, including light scatter and/or light transmission, for light emanating from the irradiated cells of the biological sample at any of a variety of angles or within any of a variety of angular ranges, including ALL and multiple distinct light scatter or propagation angles. For example, light detection assembly 350, including appropriate circuitry and/or processing units, provides a means for detecting and measuring UMALS, LMALS, LALS, MALS, and ALL.

Wires or other transmission or connectivity mechanisms can transmit signals from the electrode assembly (e.g. electrodes 334, 336), light scatter detector unit 350A, and/or light scatter and transmission detector unit 350B to analysis system 304 for processing. For example, measured DC impedance, RF conductivity, light transmission, and/or light scatter parameters can be provided or transmitted to analysis system 304 for data processing. In some instances, analysis system 304 may include computer processing features and/or one or more modules or components such as those described herein with reference to the system depicted in FIG. 6, which can evaluate the measured parameters, identify and enumerate biological sample constituents, and correlate a subset of data characterizing elements of the biological sample with an acute leukemic state of the individual. As shown here, cellular analysis system 300 may generate or output a report 306 containing the predicted leukemic state and/or a prescribed treatment regimen for the individual. In some instances, excess biological sample from transducer module 310 can be directed to an external (or alternatively internal) waste system 308. In some instances, a cellular analysis system 300 may include one or more features of a transducer module or blood analysis instrument such as those described in previously incorporated U.S. Pat. Nos. 5,125,737; 6,228,652; 8,094,299; and 8,189,187.

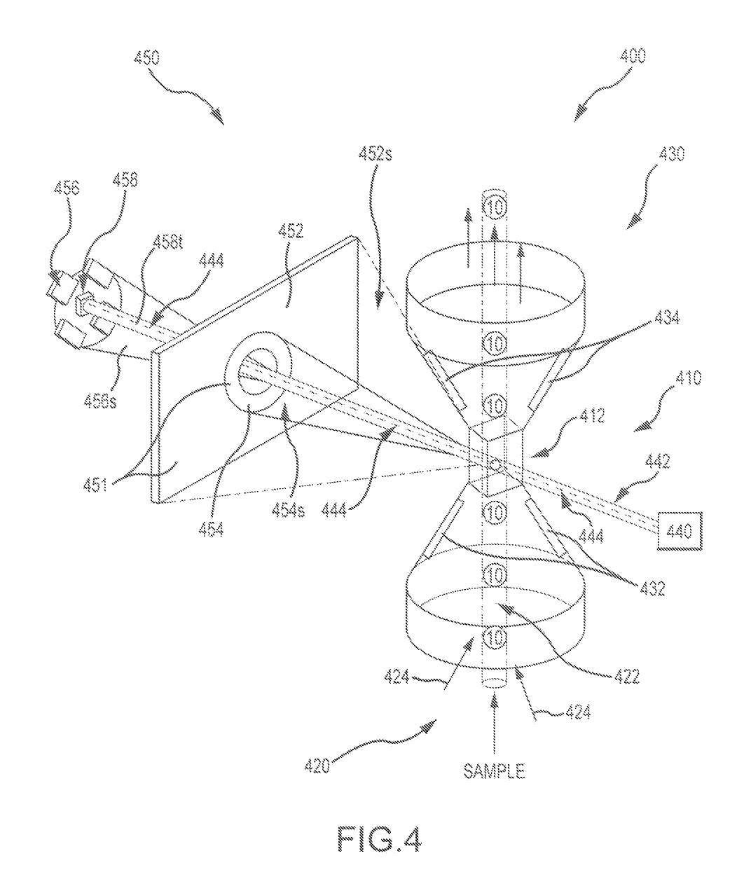

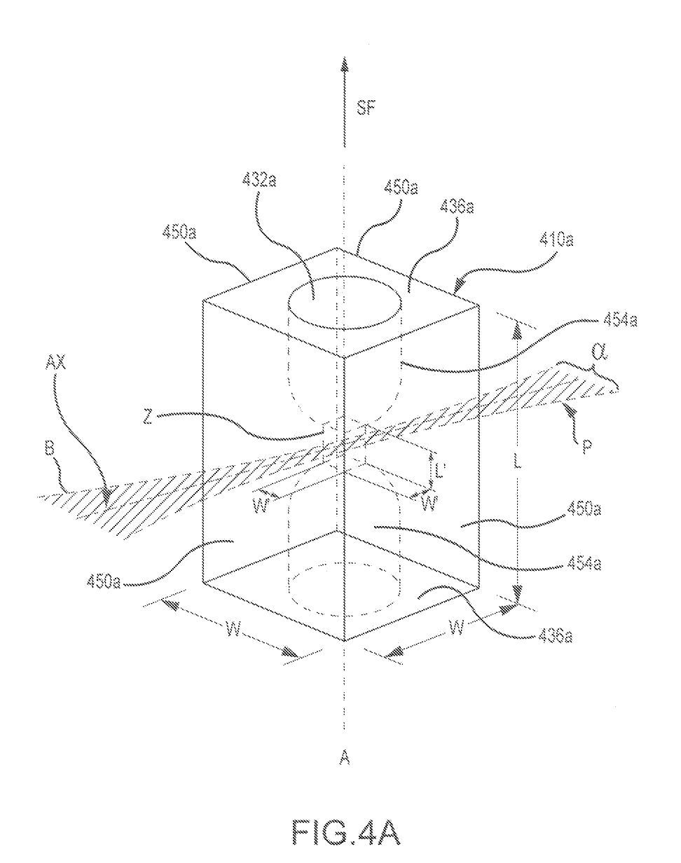

FIG. 4 illustrates aspects of an automated cellular analysis system for predicting an acute leukemia state of an individual, according to embodiments of the present invention. In particular, the acute leukemia state can be predicted based on a biological sample obtained from blood of the individual. As shown here, an analysis system or transducer 400 may include an optical element 410 having a cell interrogation zone 412. The transducer also provides a flow path 420, which delivers a hydrodynamically focused stream 422 of a biological sample toward the cell interrogation zone 412. For example, as the sample stream 422 is projected toward the cell interrogation zone 412, a volume of sheath fluid 424 can also enter the optical element 410 under pressure, so as to uniformly surround the sample stream 422 and cause the sample stream 422 to flow through the center of the cell interrogation zone 412, thus achieving hydrodynamic focusing of the sample stream. In this way, individual cells of the biological sample, passing through the cell interrogation zone one cell at a time, can be precisely analyzed.

Transducer module or system 400 also includes an electrode assembly 430 that measures direct current (DC) impedance and radiofrequency (RF) conductivity of cells 10 of the biological sample passing individually through the cell interrogation zone 412. The electrode assembly 430 may include a first electrode mechanism 432 and a second electrode mechanism 434. As discussed elsewhere herein, low-frequency DC measurements can be used to analyze the volume of each individual cell passing through the cell interrogation zone. Relatedly, high-frequency RF current measurements can be used to determine the conductivity of cells passing through the cell interrogation zone. Such conductivity measurements can provide information regarding the internal cellular content of the cells. For example, high frequency RF current can be used to analyze nuclear and granular constituents, as well as the chemical composition of the cell interior, of individual cells passing through the cell interrogation zone.

The system 400 also includes a light source 440 oriented to direct a light beam 442 along a beam axis 444 to irradiate the cells 10 of the biological sample individually passing through the cell interrogation zone 412. Relatedly, the system 400 includes a light detection assembly 450 optically coupled with the cell interrogation zone, so as to measure light scattered by and transmitted through the irradiated cells 10 of the biological sample. The light detection assembly 450 can include a plurality of light sensor zones that detect and measure light propagating from the cell interrogation zone 412. In some instances, the light detection assembly detects light propagated from the cell interrogation zone at various angles or angular ranges relative to the irradiating beam axis. For example, light detection assembly 450 can detect and measure light that is scattered at various angles by the cells, as well as light that is transmitted axially by the cells along the beam axis. The light detection assembly 450 can include a first sensor zone 452 that measures a first scattered or propagated light 452s within a first range of angles relative to the light beam axis 444. The light detection assembly 450 can also include a second sensor zone 454 that measures a second scattered or propagated light 454s within a second range of angles relative to the light beam axis 444. As shown here, the second range of angles for scattered or propagated light 454s is different from the first range of angles for scattered or propagated light 452s. Further, the light detection assembly 450 can include a third sensor zone 456 that measures a third scattered or propagated light 456s within a third range of angles relative to the light beam axis 444. As shown here, the third range of angles for scattered or propagated light 456s is different from both the first range of angles for scattered or propagated light 452s and the second range of angles for scattered or propagated light 454s. The light detection assembly 450 also includes a fourth sensor zone 458 that measures axial light 458t transmitted through the cells of the biological sample passing individually through the cell interrogation zone 412 or propagated from the cell interrogation zone along the axis beam. In some instances, each of the sensor zones 452, 454, 456, and 458 are disposed at a separate sensor associated with that specific sensor zone. In some instances, one or more of the sensor zones 452, 454, 456, and 458 are disposed on a common sensor of the light detection assembly 450. For example, the light detection assembly may include a first sensor 451 that includes first sensor zone 452 and second sensor zone 454. Hence, a single sensor may be used for detecting or measuring two or more types (e.g. low angle, medium angle, or high angle) of light scatter or propagation.

Automated cellular analysis systems may include any of a variety of optical elements or transducer features. For example, as depicted in FIG. 4A, an optical element 410a of a cellular analysis system transducer may have a square prism shape, with four rectangular, optically flat sides 450a and opposing end walls 436a. In some instances, the respective widths W of each side 450a are the same, each measuring about 4.2 mm, for example. In some instances, the respective lengths L of each side 450a are the same, each measuring about 6.3 mm, for example. In some instances, all or part of the optical element 410a may be fabricated from fused silica, or quartz. A flow passageway 432a formed through a central region of optical element 410a may be concentrically configured with respect to a longitudinal axis A passing through the center of element 410a and parallel to a direction of sample-flow as indicated by arrow SF. Flow passageway 432a includes a cell interrogation zone Z and a pair of opposing tapered bore holes 454a having openings in the vicinity of their respective bases that fluidically communicate with the cell interrogation zone. In some instances, the transverse cross-section of the cell interrogation zone Z is square in shape, the width W′ of each side nominally measuring 50 microns±10 microns. In some instances, the length L′ of the cell interrogation zone Z, measured along axis A, is about 1.2 to 1.4 times the width W′ of the interrogation zone. For example, the length L′ may be about 65 microns±10 microns. As noted elsewhere herein, DC and RF measurements can be made on cells passing through the cell interrogation zone. In some instances, the maximum diameter of the tapered bore holes 454a, measured at end walls 436a, is about 1.2 mm. An optical structure 410a of the type described can be made from a quartz square rod containing a 50×50 micron capillary opening, machined to define the communicating bore holes 454a, for example. A laser or other irradiation source can produce a beam B that is directed through or focused into the cell interrogation zone. For example, the beam may be focused into an elliptically shaped waist located within the interrogation zone Z at a location through which the cells are caused to pass. A cellular analysis system may include a light detection assembly that is configured to detect light which emanates from the optical element 410a, for example light P that is propagated from the cell interrogation zone Z which contains illuminated or irradiated cells flowing therewithin. As depicted here, light P can propagate or emanate from the cell interrogation zone Z within an angular range α, and thus can be measured or detected at selected angular positions or angular ranges relative to the beam axis AX. Relatedly, a light detection assembly can detect light scattered or axially transmitted in a forward plane within various angular ranges with respect to an axis AX of beam B. As discussed elsewhere herein, one or more light propagation measurements can be obtained for individual cells passing through the cell interrogation zone one at a time. In some cases, a cellular analysis system may include one or more features of a transducer or cell interrogation zone such as those described in U.S. Pat. Nos. 5,125,737; 6,228,652; 8,094,299; and 8,189,187, the contents of which are incorporated herein by reference.

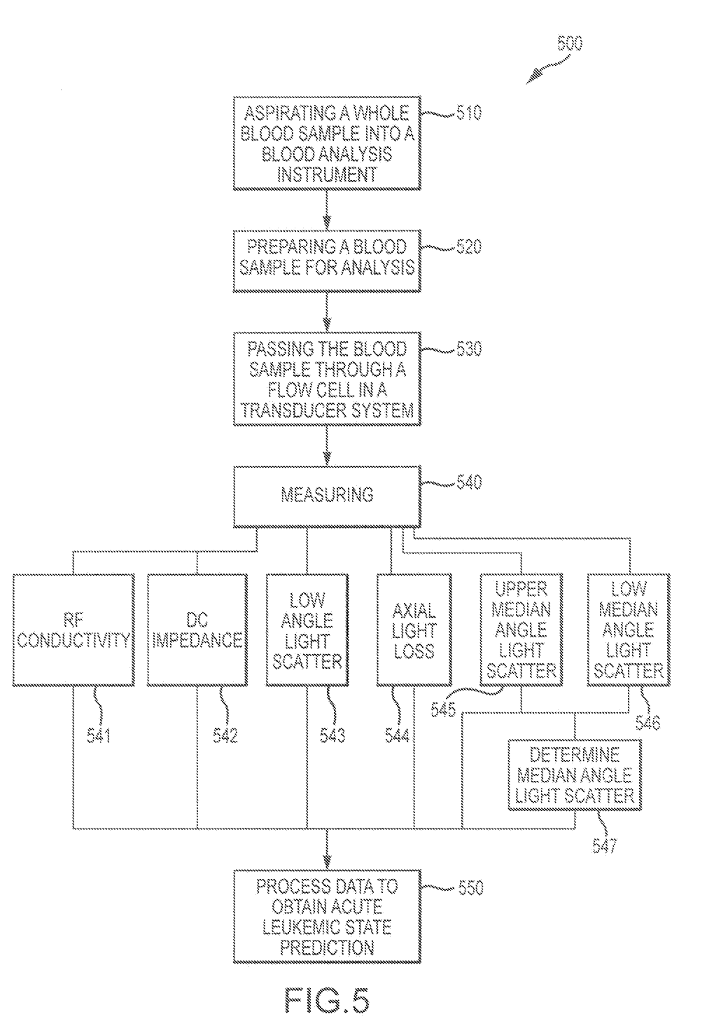

FIG. 5 depicts aspects of an exemplary method 500 for predicting an acute leukemic state of an individual. Method 500 includes introducing a blood sample into a blood analysis system, as indicated by step 510. As shown in step 520, the method may also include preparing the blood sample by dividing the sample into aliquots and mixing the aliquot samples with appropriate reagents. In step 530, the samples can be passed through a flow cell in a transducer system such that sample constituents (e.g. blood cells) pass through a cell interrogation zone in a one by one fashion. The constituents can be irradiated by a light source, such as a laser. In step 540, any combination RF conductivity 541, DC impedance 542, first angular light propagation 543 (e.g. LALS), second angular light propagation 544 (e.g. AL2), third angular light propagation 545 (e.g. UMAL), and/or fourth angular light propagation 546 (e.g. LMALS) may be measured. As depicted by step 547, the third and fourth angular light propagation measurements can be used to determine a fifth angular light propagation measurement (e.g. MALS). Alternatively, MALS can be measured directly. As discussed elsewhere herein, certain measurements or combinations of measurements can be processed, as indicated by step 550, so as to provide an acute leukemic state prediction. Optionally, methods may also include determining a treatment regime based on the predicted acute leukemic state.

A cellular analysis system may be configured to correlate a subset of DC impedance, RF conductivity, angular light measurements (e.g. first scattered light, second scattered light) and the axial light measurements from the cells of the biological sample with an acute leukemic state or sub-type of an individual that presents with symptoms of acute leukemia. As discussed elsewhere herein, in some instances at least a portion of the correlation can be performed using one or more software modules executable by one or more processors, one or more hardware modules, or any combination thereof. Processors or other computer or module systems may be configured to receive as an input values for the various measurements or parameters and automatically output the predicted acute leukemic state or sub-type of the individual diagnosed as having acute leukemia. In some instances, one or more of the software modules, processors, and/or hardware modules may be included as a component of a hematology system that is equipped to obtain multiple light angle detection parameters, such as Beckman Coulter's UniCel® DxH™ 800 Cellular Analysis System. In some instances, one or more of the software modules, processors, and/or hardware modules may be includes as a component of a stand-alone computer that is in operative communication or connectivity with a hematology system that is equipped to obtain multiple light angle detection parameters, such as Beckman Coulter's UniCel® DxH 800 System. In some instances, at least a portion of the correlation can be performed by one or more of the software modules, processors, and/or hardware modules that receive data from a hematology system that is equipped to obtain multiple light angle detection parameters, such as Beckman Coulter's UniCel® DxH 800 System remotely via the internet or any other over wired and/or wireless communication network. Relatedly, each of the devices or modules according to embodiments of the present invention can include one or more software modules on a computer readable medium that is processed by a processor, or hardware modules, or any combination thereof.

FIG. 6 is a simplified block diagram of an exemplary module system that broadly illustrates how individual system elements for a module system 600 may be implemented in a separated or more integrated manner. Module system 600 may be part of or in connectivity with a cellular analysis system for predicting an acute leukemia state or sub-type of an individual presenting with acute leukemia symptoms according to embodiments of the present invention. Module system 600 is well suited for producing data or receiving input related to an acute leukemia analysis. In some instances, module system 600 includes hardware elements that are electrically coupled via a bus subsystem 602, including one or more processors 604, one or more input devices 606 such as user interface input devices, and/or one or more output devices 608 such as user interface output devices. In some instances, system 600 includes a network interface 610, and/or a diagnostic system interface 640 that can receive signals from and/or transmit signals to a diagnostic system 642. In some instances, system 600 includes software elements, for example shown here as being currently located within a working memory 612 of a memory 614, an operating system 616, and/or other code 618, such as a program configured to implement one or more aspects of the techniques disclosed herein.

In some embodiments, module system 600 may include a storage subsystem 620 that can store the basic programming and data constructs that provide the functionality of the various techniques disclosed herein. For example, software modules implementing the functionality of method aspects, as described herein, may be stored in storage subsystem 620. These software modules may be executed by the one or more processors 604. In a distributed environment, the software modules may be stored on a plurality of computer systems and executed by processors of the plurality of computer systems. Storage subsystem 620 can include memory subsystem 622 and file storage subsystem 628. Memory subsystem 622 may include a number of memories including a main random access memory (RAM) 626 for storage of instructions and data during program execution and a read only memory (ROM) 624 in which fixed instructions are stored. File storage subsystem 628 can provide persistent (non-volatile) storage for program and data files, and may include tangible storage media which may optionally embody patient, treatment, assessment, or other data. File storage subsystem 628 may include a hard disk drive, a floppy disk drive along with associated removable media, a Compact Digital Read Only Memory (CD-ROM) drive, an optical drive, DVD, CD-R, CD RW, solid-state removable memory, other removable media cartridges or disks, and the like. One or more of the drives may be located at remote locations on other connected computers at other sites coupled to module system 600. In some instances, systems may include a computer-readable storage medium or other tangible storage medium that stores one or more sequences of instructions which, when executed by one or more processors, can cause the one or more processors to perform any aspect of the techniques or methods disclosed herein. One or more modules implementing the functionality of the techniques disclosed herein may be stored by file storage subsystem 628. In some embodiments, the software or code will provide protocol to allow the module system 600 to communicate with communication network 630. Optionally, such communications may include dial-up or internet connection communications.

It is appreciated that system 600 can be configured to carry out various aspects of methods of the present invention. For example, processor component or module 604 can be a microprocessor control module configured to receive cellular parameter signals from a sensor input device or module 632, from a user interface input device or module 606, and/or from a diagnostic system 642, optionally via a diagnostic system interface 640 and/or a network interface 610 and a communication network 630. In some instances, sensor input device(s) may include or be part of a cellular analysis system that is equipped to obtain multiple light angle detection parameters, such as Beckman Coulter's UniCel® DxH™ 800 Cellular Analysis System. In some instances, user interface input device(s) 606 and/or network interface 610 may be configured to receive cellular parameter signals generated by a cellular analysis system that is equipped to obtain multiple light angle detection parameters, such as Beckman Coulter's UniCel® DxH™ 800 Cellular Analysis System. In some instances, diagnostic system 642 may include or be part of a cellular analysis system that is equipped to obtain multiple light angle detection parameters, such as Beckman Coulter's UniCel® DxH™ 800 Cellular Analysis System.

Processor component or module 604 can also be configured to transmit cellular parameter signals, optionally processed according to any of the techniques disclosed herein, to sensor output device or module 636, to user interface output device or module 608, to network interface device or module 610, to diagnostic system interface 640, or any combination thereof. Each of the devices or modules according to embodiments of the present invention can include one or more software modules on a computer readable medium that is processed by a processor, or hardware modules, or any combination thereof. Any of a variety of commonly used platforms, such as Windows, MacIntosh, and Unix, along with any of a variety of commonly used programming languages, may be used to implement embodiments of the present invention.

User interface input devices 606 may include, for example, a touchpad, a keyboard, pointing devices such as a mouse, a trackball, a graphics tablet, a scanner, a joystick, a touchscreen incorporated into a display, audio input devices such as voice recognition systems, microphones, and other types of input devices. User input devices 606 may also download a computer executable code from a tangible storage media or from communication network 630, the code embodying any of the methods or aspects thereof disclosed herein. It will be appreciated that terminal software may be updated from time to time and downloaded to the terminal as appropriate. In general, use of the term “input device” is intended to include a variety of conventional and proprietary devices and ways to input information into module system 600.

User interface output devices 606 may include, for example, a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide a non-visual display such as via audio output devices. In general, use of the term “output device” is intended to include a variety of conventional and proprietary devices and ways to output information from module system 600 to a user.

Bus subsystem 602 provides a mechanism for letting the various components and subsystems of module system 600 communicate with each other as intended or desired. The various subsystems and components of module system 600 need not be at the same physical location but may be distributed at various locations within a distributed network. Although bus subsystem 602 is shown schematically as a single bus, alternate embodiments of the bus subsystem may utilize multiple busses.

Network interface 610 can provide an interface to an outside network 630 or other devices. Outside communication network 630 can be configured to effect communications as needed or desired with other parties. It can thus receive an electronic packet from module system 600 and transmit any information as needed or desired back to module system 600. As depicted here, communication network 630 and/or diagnostic system interface 642 may transmit information to or receive information from a diagnostic system 642 that is equipped to obtain multiple light angle detection parameters, such as such as Beckman Coulter's UniCel® DxH™ 800 Cellular Analysis System.

In addition to providing such infrastructure communications links internal to the system, the communications network system 630 may also provide a connection to other networks such as the internet and may comprise a wired, wireless, modem, and/or other type of interfacing connection.

It will be apparent to the skilled artisan that substantial variations may be used in accordance with specific requirements. For example, customized hardware might also be used and/or particular elements might be implemented in hardware, software (including portable software, such as applets), or both. Further, connection to other computing devices such as network input/output devices may be employed. Module terminal system 600 itself can be of varying types including a computer terminal, a personal computer, a portable computer, a workstation, a network computer, or any other data processing system. Due to the ever-changing nature of computers and networks, the description of module system 600 depicted in FIG. 6 is intended only as a specific example for purposes of illustrating one or more embodiments of the present invention. Many other configurations of module system 600 are possible having more or less components than the module system depicted in FIG. 6. Any of the modules or components of module system 600, or any combinations of such modules or components, can be coupled with, or integrated into, or otherwise configured to be in connectivity with, any of the cellular analysis system embodiments disclosed herein. Relatedly, any of the hardware and software components discussed above can be integrated with or configured to interface with other medical assessment or treatment systems used at other locations.

In some embodiments, the module system 600 can be configured to receive one or more cellular analysis parameters of a patient at an input module. Cellular analysis parameter data can be transmitted to an assessment module where an acute leukemic state or sub-type of an individual, previously diagnosed with acute leukemia, is predicted or determined. The acute leukemic state or sub-type can be output to a system user via an output module. In some cases, the module system 600 can determine an initial treatment or induction protocol for the patient, based on one or more cellular analysis parameters and/or the predicted leukemia state or sub-type, for example by using a treatment module. The treatment can be output to a system user via an output module. Optionally, certain aspects of the treatment can be determined by an output device, and transmitted to a treatment system or a sub-device of a treatment system. Any of a variety of data related to the patient can be input into the module system, including age, weight, sex, treatment history, medical history, and the like. Parameters of treatment regimens or diagnostic evaluations can be determined based on such data.

Relatedly, in some instances a system includes a processor configured to receive the cell population data as input. Optionally, a processor, storage medium, or both, may be incorporated within a hematology or cellular analysis machine. In some instances, the hematology machine may generate cell population data or other information for input into the processor. In some instances, a processor, a storage medium, or both, can be incorporated within a computer, and the computer can be in communication with a hematology machine. In some instances, a processor, a storage medium, or both, can be incorporated within a computer, and the computer can be in remote communication with a hematology machine via a network.

Cell Population Data

In addition to a differential count, once the WBC sub-populations are formed, the mean (MN) and standard deviation (SD) values for the grades of various morphologic parameters (e.g. volume, conductivity, and angles of light scatter or propagation) can be calculated separately for leukocytes and other blood cells. For example, a WBC differential channel can provide measurement data for neutrophils, lymphocytes, monocytes, and eosinophils, and an nRBC channel can provide measurement data for non-nucleated red blood cells or a non-nucleated red blood cell parameter, as described elsewhere herein. As a result, a vast amount of data directly correlating to blood cell morphology can be generated. This information can be called collectively “Cell Population Data” (CPD). Table 1 depicts a variety of Cell Population Data parameters which may be obtained based on a biological sample of an individual.

TABLE 1

| | | | | | Non-nucleated |
|---|---|---|---|---|---|
| | | | Monocyte | | red blood cell |
| | Neutrophil | Lymphocyte | MO (mo or | Eosinophil | NNRBC (nnr or |
| | NE (ne) | LY (ly) | mn) | EO (eo) | nnrbc) |
| Cell | SD-C-NE | SD-C-LY | SD-C-MO | SD-C-EO | SD-C-NNRBC |
| Conductivity | MN-C-NE | MN-C-LY | MN-C-MO | MN-C-EO | MN-C-NNRBC |
| (C) | | | | | |
| high freq. | | | | | |
| current | | | | | |
| Cell Volume | SD-V-NE | SD-V-LY | SD-V-MO | SD-V-EO | SD-V-NNRBC |
| (V) | MN-V-NE | MN-V-LY | MN-V-MO | MN-V-EO | MN-V-NNRBC |
| low freq. | | | | | |
| current | | | | | |
| Axial light | SD-AL2-NE | SD-AL2-LY | SD-AL2- | SD-AL2-EO | SD-AL2-NNRBC |
| loss or | MN-AL2- | MN-AL2-LY | MO | MN-AL2- | MN-AL2- |
| absorbed | NE | | MN-AL2- | EO | NNRBC |
| light (AL2 or | | | MO | | |
| ALL) | | | | | |
| Low-angle | SD-LALS- | SD-LALS- | SD-LALS- | SD-LALS- | SD-LALS- |
| light scatter | NE | LY | MO | EO | NNRBC |
| (LALS) | MN-LALS- | MN-LALS- | MN-LALS- | MN-LALS- | MN-LALS- |
| | NE | LY | MO | EO | NNRBC |
| Upper | SD- | SD-UMALS- | SD- | SD- | SD-UMALS- |
| median-angle | UMALS-NE | LY | UMALS- | UMALS-EO | NNRBC |
| light scatter | MN- | MN- | MO | MN- | MN-UMALS- |
| (UMALS) | UMALS-NE | UMALS-LY | MN- | UMALS-EO | NNRBC |
| | | | UMALS- | | |
| | | | MO | | |
| Lower | SD-LMALS- | SD-LMALS- | SD-LMALS- | SD-LMALS- | SD-LMALS- |
| median-angle | NE | LY | MO | EO | NNRBC |
| light scatter | MN- | MN- | MN- | MN- | MN-LMALS- |
| (LMALS) | LMALS-NE | LMALS-LY | LMALS-MO | LMALS-EO | NNRBC |
| Median- | SD-MALS- | SD-MALS- | SD-MALS- | SD-MALS- | SD-MALS- |
| angle light | NE | LY | MO | EO | NNRBC |
| scatter | MN-MALS- | MN-MALS- | MN-MALS- | MN-MALS- | MN-MALS- |
| (MALS) | NE | LY | MO | EO | NNRBC |
| [UMALS + | | | | | |
| LMALS] | | | | | |

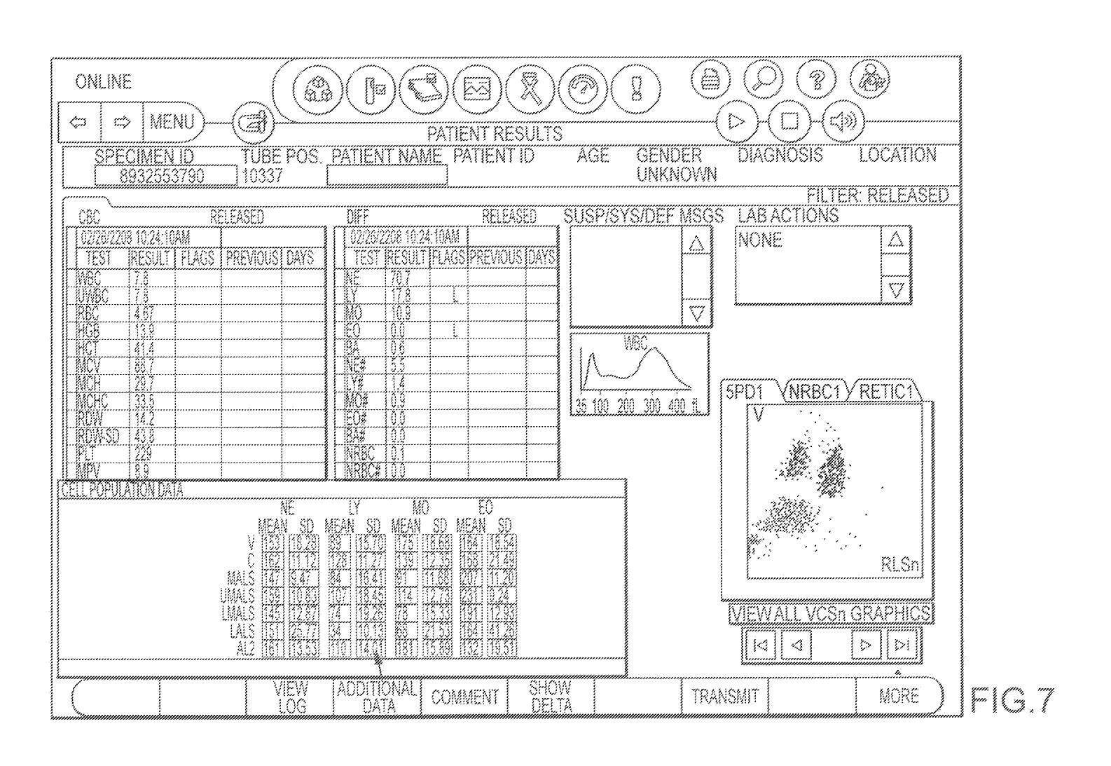

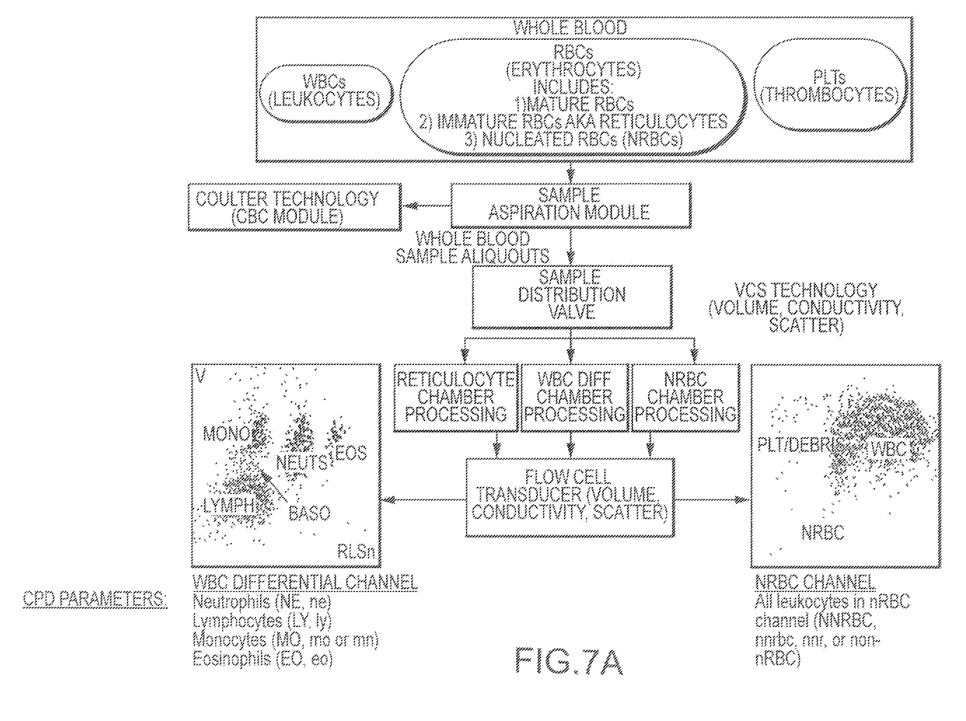

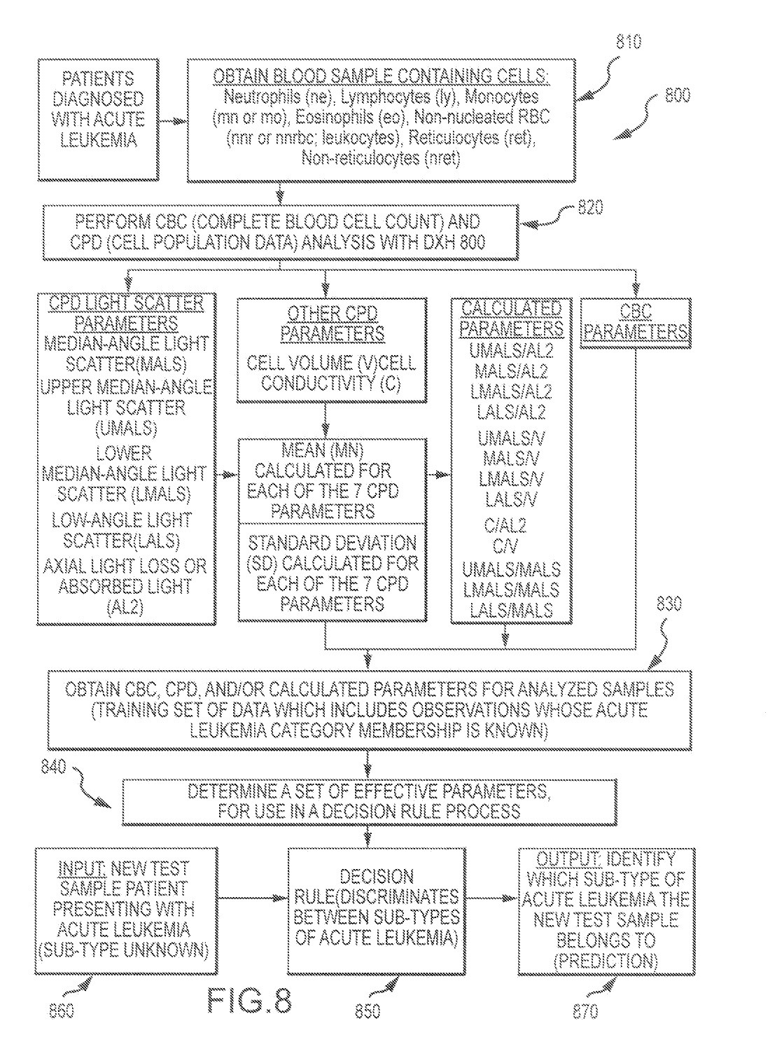

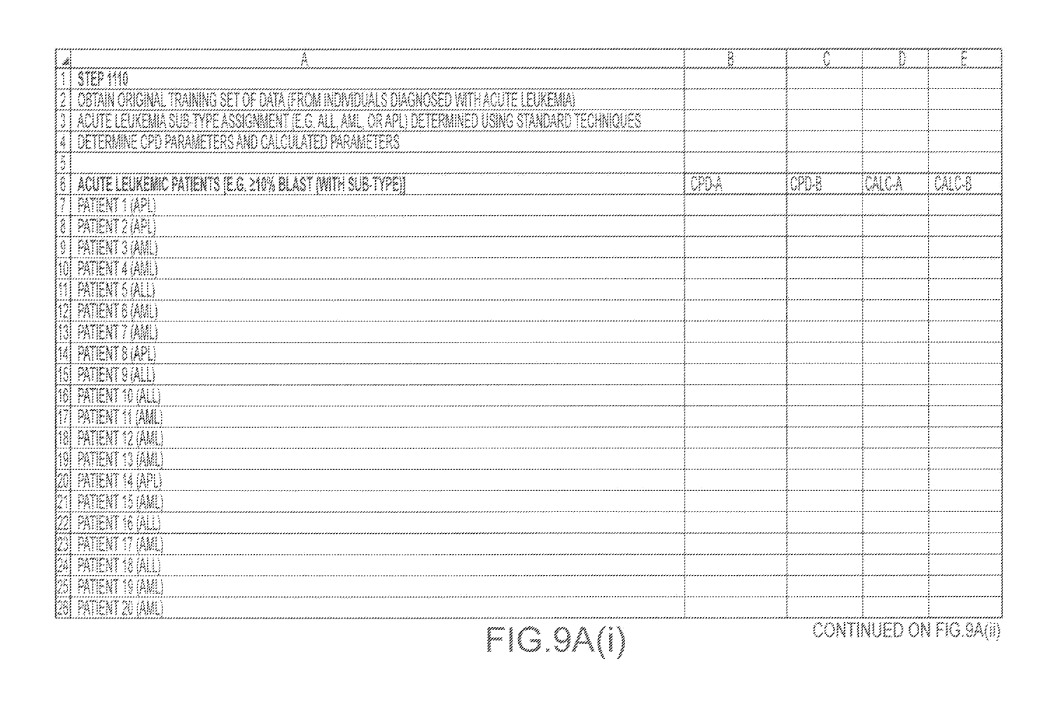

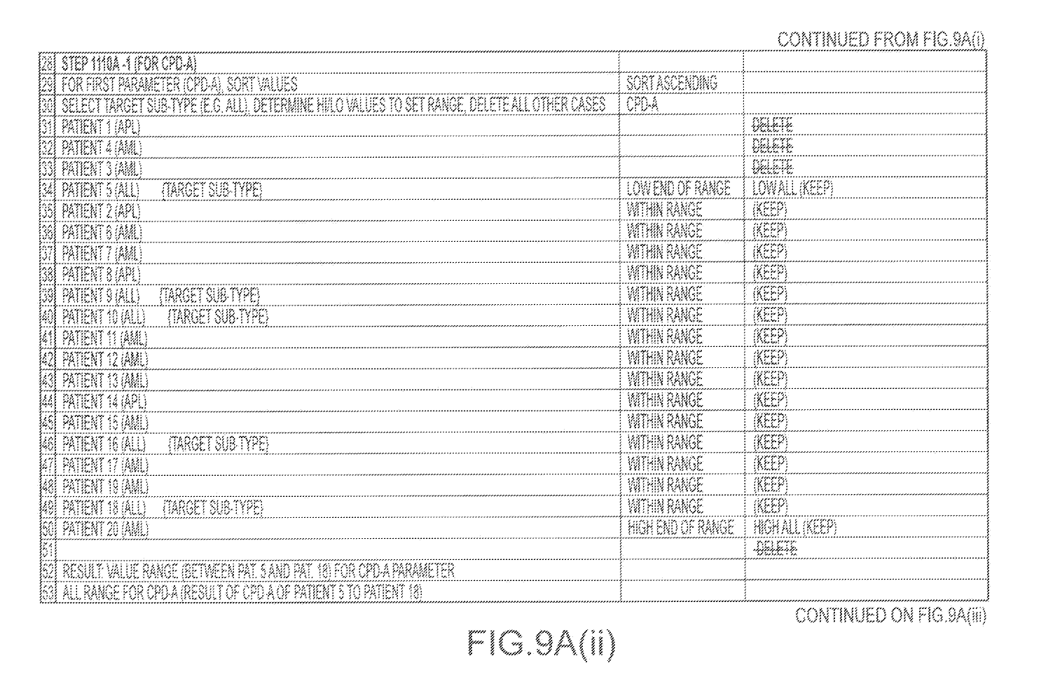

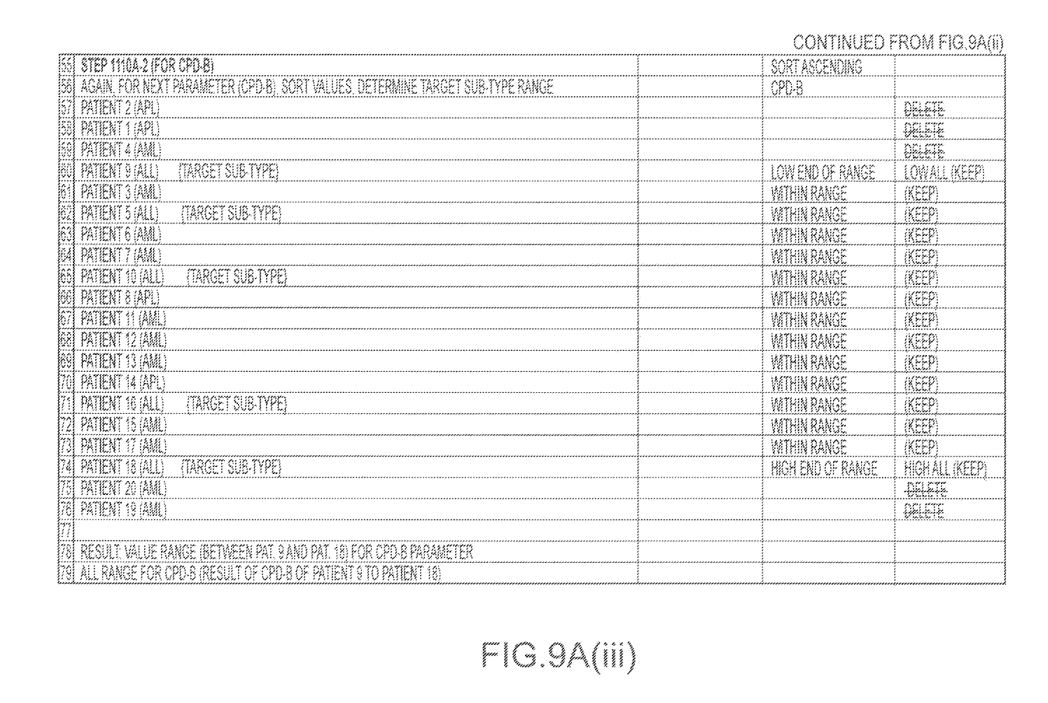

CPD values can be viewed on the screen of an instrument, such as that depicted in FIG. 7, as well as automatically exported as an Excel file. Hence, white blood cells (WBC's) can be analyzed and individually plotted in tri-dimensional histograms, with the position of each cell on the histogram being defined by certain parameters as described herein. In some instances, systems or methods can grade the cell in a range from 1 to 256 points, for each of the parameters.

Because WBCs of the same sub-type, for example granulocytes (or neutrophils), lymphocytes, monocytes, eosinophils, and basophils, often have similar morphologic features, they may tend to be plotted in similar regions of the tri-dimensional histogram, thus forming cell populations. The number of events in each population can be used to generate a differential count. FIG. 7 depicts an exemplary screen shot of a differential count screen. As illustrated here, the WBC sub-populations are in clearly separated groups at different locations on the histogram, and are defined by different colors. The histogram shown here provides cell size (volume) in the y axis and light scatter in the x axis.

By clicking on the “Additional Data” tab, users can view the CPD values. Such CPD values can correspond to the position of the population in the histogram, and to the morphology of the WBCs under the microscope. For example, monocytes are known to be the largest of all WBCs, and have the highest mean volume. Lymphocytes are known to be the smallest of all WBCs, and have the lowest mean volume. Lymphocytes also have the lowest level of cytoplasmic granularity and the least complex nuclear morphology, and have the lowest mean light scatter, called MALS). As depicted in FIG. 7A, the WBC differential channel can provide measurement data for neutrophils, lymphocytes, monocytes, and eosinophils. The nRBC channel can provide measurement data for non-nucleated red blood cells (nnRBC). As discussed herein, the term nnRBC can refer to all leukocytes in the nRBC channel. In the nRBC chamber, a portion of a whole blood sample can be diluted and treated with a lysing reagent that selectively removes non-nucleated red blood cells, and that maintains the integrity of nucleated red blood cells (nRBCs), white blood cells (WBCs), and any platelets or cellular debris that may be present.

CPD parameters can be used to analyze cellular morphology in a quantitative, objective, and automated manner, free from the subjectivity of human interpretation, which is also very time consuming, expensive, and has limited reproducibility. CPD parameters can be used for improving the value of the CBC-diff in the diagnosis of various medical conditions that alter the morphology of WBCs.

As further discussed herein, it has been discovered that certain CPD parameter values or value ranges are highly useful for predicting an acute leukemic state or sub-type of an individual previously diagnosed with acute leukemia. Accordingly, these parameter values or value ranges can be implemented in systems and methods for the differential diagnosis of acute leukemias.

Calculated Parameters

Table 2 depicts a variety of calculated parameters which may be obtained based on a biological sample of an individual. According to some embodiments, a calculated parameter can refer to a relation or ratio between two CPD parameters. For example, the calculated parameter ne-umals/al2 refers to the ratio of UMALS to AL2 for neutrophils.

TABLE 2

| | | | | | Non-nucleated |
|---|---|---|---|---|---|
| | | | Monocyte | | red blood cell |
| | Neutrophil | Lymphocyte | MO (mo or | Eosinophil | NNRBC (nnr or |
| | NE (ne) | LY (ly) | mn) | EO (eo) | nnrbc) |
| umals/al2 | ne umals/al2 | ly umals/al2 | mn umals/al2 | eo umals/al2 | nnrbc umals/al2 |
| mals/al2 | ne mals/al2 | ly mals/al2 | mn mals/al2 | eo mals/al2 | nnrbc mals/al2 |
| lmals/al2 | ne lmals/al2 | ly lmals/al2 | mn lmals/al2 | eo lmals/al2 | nnrbc lmals/al2 |
| lals/al2 | ne lals/al2 | ly lals/al2 | mn mn | eo lals/al2 | nnrbc lals/al2 |
| | | | lals/al2 | | |
| umals/v | ne umals/v | ly umals/v | mn mn | eo umals/v | nnrbc umals/v |
| | | | umals/v | | |
| mals/v | ne mals/v | ly mals/v | mn mals/v | eo mals/v | nnrbc mals/v |
| lmals/v | ne lmals/v | ly lmals/v | mn lmals/v | eo lmals/v | nnrbc lmals/v |
| lals/v | ne lals/v | ly lals/v | mn mn lals/v | eo lals/v | nnrbc lals/v |
| v/al2 | ne v/al2 | ly v/al2 | mn mn v/al2 | eo v/al2 | nnrbc v/al2 |
| c/al2 | ne c/al2 | ly c/al2 | mn c/al2 | eo c/al2 | nnrbc c/al2 |
| c/v | ne c/v | ly c/v | mn c/v | eo c/v | nnrbc c/v |
| umals/mals | ne | ly umals/mals | mn | eo | nnrbc |
| | umals/mals | | umals/mals | umals/mals | umals/mals |
| lmals/mals | ne | ly lmal/mals | mn | eo | nnrbc lmals/mals |
| | lmals/mals | | lmals/mals | lmals/mals | |
| lals/mals | ne lals/mals | ly lals/mals | mn lals/mals | eo lals/mals | nnrbc lals/mals |

It has been discovered that particular values or value ranges of certain calculated parameters are highly useful for predicting an acute leukemic state or sub-type of an individual previously diagnosed with acute leukemia. Accordingly, these calculated parameter values or ranges can be implemented in systems and methods for the differential diagnosis of acute leukemias.

Decision Rules

Embodiments of the present invention encompass multiparametric techniques based on CPD and calculated parameters that can reliably predict the lineage in new cases of acute leukemia. Such predictions can be used when developing a treatment or induction therapy. In some cases, such treatments or therapies can be determined before immunophenotype results are available. By providing accurate predictions of acute leukemic states or sub-types in an individual presenting with acute leukemia, there is a lower risk that an inappropriate drug regimen will be used.

FIG. 8 schematically illustrates a method 800 for obtaining and using a decision rule according to embodiments of the present invention. As depicted here, the method includes obtaining blood samples from individuals having acute leukemia, as indicated by step 810. Complete blood count (CBC) and/or CPD data can be obtained from these biological samples, using a cellular analysis system that is equipped to obtain multiple light angle detection parameters, such as Beckman Coulter's UniCel® DxH 800 System, as indicated by step 820. CBC, CPD, and/or calculated parameters from analyzed samples can be used to build a training set of data, which includes observations whose acute leukemia category membership (e.g. ALL, AMP, or APL) is known, as shown by step 830. The method also includes determining a set of effective parameters based on the training set of data, for use in a decision rule process, as indicated by step 840. As shown here, a decision rule 850, which is based on the set of effective parameters, can be used to analyze a new unknown test sample 860 of an individual diagnosed with acute leukemia, in order to predict an acute leukemic state or sub-type 870 of the individual.

Analysis System Programmed with Decision Rules

Embodiments of the present invention encompass cellular analysis systems and other automated biological investigation devices which are programmed to carry out acute leukemia sub-type prediction or identification methods according to decision rules as disclosed herein. For example, a systems that is equipped to obtain and/or process multiple light angle detection parameters, such as Beckman Coulter's UniCel® DxH 800 System, or processors or other computer or module systems associated therewith or incorporated therein, can be configured based on decision rules described herein to receive as input values for the various measurements or parameters discussed herein, and automatically output a predicted acute leukemic state or sub-type. In some instances, a system that is equipped to obtain and/or process multiple light angle detection parameters, such as a Beckman Coulter UniCel® DxH 800 System, may include a processor or storage medium that is configured to automatically implement an acute leukemia decision rule, whereby data obtained from a biological sample analyzed by a system that is equipped to obtain multiple light angle detection parameters, such as the DxH 800 System, is also processed by a system that is equipped to obtain and/or process multiple light angle detection parameters, such as the DxH 800 System, and an acute leukemia sub-type prediction or indication is provided or output by the system that is equipped to obtain and/or process multiple light angle detection parameters, such as the DxH 800 System, based on the analyzed data.

### Example

A study was performed based on all newly diagnosed cases of acute leukemia which presented to the Seoul St. Mary's Hospital, Seoul, Korea, between July 2009 and August 2011. A total of 503 cases included in the study received a complete diagnostic work-up as routinely performed for patient care. For cases of AML with recurrent genetic abnormalities, a minimum blast percentage of 10% was required for inclusion in the study, since smaller percentages would not be sufficient to impact the CPD. The exact leukemia sub-type was identified based on multiple laboratory tests performed as part of the routine diagnostic work-up, including CBC-diff, microscopic review of the peripheral blood and bone marrow aspirate, bone marrow biopsy, flow cytometry, and cytogenetic and molecular studies when clinically indicated.

Based on the final hematopathology report, all cases of diagnosed acute leukemia were assigned to one of the three major treatment groups that require different induction regimens (ALL, APL, and AML). Cases that were diagnosed as mixed phenotype acute leukemia (MPAL) were included in the AML group because of the induction regimen they usually receive.

Once the acute leukemia cases were assigned to their respective diagnostic groups, they were further separated in two different study sets, per order of inclusion in the study. For example, the first and third AMLs included in the study went to set A, and the second and fourth went to set B. The final classification of acute leukemia patients is depicted in Table 3.

TABLE 3

| | ALL | AML | APL |
|---|---|---|---|
| Set A | 47 cases | 145 cases | 9 cases |
| Set B | 47 cases | 145 cases | 10 cases |

CPD data was obtained from all acute leukemia cases in the study and input into a spreadsheet (Excel). Each of the acute leukemia cases were identified within the spreadsheet as belonging to one of the acute leukemia sub-types (ALL, AML, or APL). With this data, a data analysis technique was used to compare these groups of acute leukemia cases and generate combinations of CPD based rules that could best predict in which of the above groups or sub-types an unknown case of acute leukemia would fall. In some instances, calculated parameters (e.g. ratios between various CPD parameters) were used, which allows for the presence of automatic internal controls for possible variations that may be inherent to the instrument, such as dilution variability, voltage changes, the exact positioning of the laser beam, and several other factors that may affect the instrument reading, but in doing so results are affected equally across WBC sub-types.

The data analysis technique was performed using a multistep strategy. Briefly, effective parameters were selected for screening at desired sensitivity and/or specificity values. Certain values or value ranges for these effective parameters were determined which resulted in the decision rules. The sensitivity and specificity for the decision rules were then calculated. The combination and range of CPD and calculated parameters that can discriminate acute leukemic states (e.g. from other diseases and normal controls) can be determined using an Excel macroprogram.

In a first step, characteristic CPD and calculated parameter patterns of acute lymphoblastic leukemia cases were identified. A multiparametric model was developed that could predict whether an unknown case would be acute lymphoblastic leukemia (ALL). The sensitivity and the specificity of the model was evaluated. In this first step, cases were categorized as being either ALL or non-ALL.

For this step, case set A (“test set”) was used to identify the characteristic CPD and calculated parameter patterns of acute lymphoblastic leukemia cases and to develop the multiparametric model for discriminating such cases. Once the model was developed, it was applied blindly to case set B (“validation set”), to calculate the sensitivity and specificity of the model in an unknown and totally different set of cases, thus simulating the performance such models would have in a real life scenario being used in a routine hematology laboratory.

Using case set A, 36 cell population data and calculated parameters were identified for incorporation into a prediction model for identifying cases of acute lymphoblastic leukemia (ALL) among all other types of acute leukemias. The list of these parameter and ratios, along with the cut-off points applied in the characterization of acute lymphoblastic leukemia (ALL), is shown in Table 4. Hence, this table provides an exemplary decision rule for distinguishing acute lymphoblastic leukemia (ALL) from all other types of acute leukemia, using 36 leukocyte cell population data and calculated parameters.

TABLE 4

| Parameter (unit) | range | Parameter (unit) | range |
|---|---|---|---|
| ne umals/mals | 0.3-0.79 | MN-V-LY | <1.5 |
| mn lals/al2 | 0.3-0.79 | MN-C-LY | <1.16 |
| mn v/al2 | 1.05< | SD-C-LY | 0.58-2.6 |
| mn umals/v | 0.27-0.74 | MN-LALS-LY | <1.71 |
| mn lals/v | <0.53 | MN-AL2-LY | <1.5 |
| mn c/v | 0.3-0.796 | MN-V-MO | 0.9< |
| mn umals/mals | <1.14 | SD-V-MO | 0.2< |
| mn lmals/mals | 0.82-1 | MN-C-MO | <1.009 |
| mn lals/mals | <1.25 | SD-C-MO | 0.91-7 |
| eo lmals/mals | 0.86-1 | MN-LMALS-MO | 0.72-1.55 |
| nnr lmals/al2 | 0.844< | MN-LALS-MO | <1.13 |
| nnr lals/al2 | 0.23-1 | MN-AL2-MO | <1.31 |
| nnr lmals/mals | 1-1.14 | MN-V-EO | <1.205 |
| SD-C-NE | 1.025< | SD-V-EO | <2.5 |
| MN-UMALS-NE | 0.82< | MN-LMALS-EO | <1.04 |
| SD-UMALS-NE | <3 | MN-C-NNR | <1.43 |
| SD-LMALS-NE | 0.8-2.3 | SD-C-NNR | 0.8< |
| SD-AL2-NE | 1.1-5 | SD-UMALS-NNR | <1.2 |

For the “test set”, this 36 parameter model correctly identified 44 out of 47 acute lymphoblastic leukemia (ALL) cases (93.62% sensitivity), and correctly ruled out acute lymphoblastic leukemia (ALL) in 151 out of 154 cases of other types of acute leukemias (98.05% specificity). Hence, it has been discovered that certain CPD parameter values or value ranges, in combination with certain calculated parameter values of value ranges, are highly useful for predicting an acute leukemic state of an individual, or for providing a differential diagnosis for acute leukemias.

In a second step, a similar analysis was performed for discriminating cases of acute promyelocytic leukemia (APL) from all other cases. Sensitivity and specificity of the developed model was also evaluated. Cases that would neither fit the category of ALL nor APL, were deemed to be either AML (vast majority of cases), or MPAL, both of which would receive an identical induction regimen.

Again, a case set A (“test set”) was initially used to identify the characteristic cell population and calculated parameter patterns for APL cases, and to develop a multiparametric model for discriminating such cases. Once the models was developed, it was applied blindly to case set B (“validation set”), to calculate the sensitivity and specificity of the models in an unknown and totally different set of cases, thus simulating the performance such models would have in a real life scenario being used in a routine hematology laboratory.

Using case set A, 13 parameters and parameter ratios were identified that could be incorporated into a prediction model for identifying cases of APL among all other types of acute leukemias. As above, Table 5 shows the list of parameters and parameter ratios and cut-off points utilized. Hence, this table provides an exemplary decision rule for distinguishing acute promyelocytic leukemia (APL) from all other types of acute leukemia, using 13 leukocyte cell population data and calculated parameters.

TABLE 5

| Parameter (unit) | range | Parameter (unit) | range |
|---|---|---|---|
| ne c/al2 | <1.2 | MN-V-MO | 1.03< |
| ly lmals/mals | 0.78< | MN-LMALS-MO | 0.7< |
| eo lmals/al2 | 0.91-2.4 | SD-AL2-MO | 1.6< |
| nnr lals/v | <0.8 | MN-MALS-EO | <0.97 |
| MN-LALS-NE | 0.55-0.9 | MN-V-NNR | 0.7< |
| MN-MALS-NE | <1.06 | SD-MALS-NNR | <1.2 |
| MN-V-LY | <1.12 | | |

In this “test set”, the 13 parameter model correctly identified all 9 cases of APL (100% sensitivity), and correctly ruled out APL in all 192 cases of other types of acute leukemias (100% specificity). Hence, it has been discovered that certain CPD parameter values or value ranges, in combination with certain calculated parameter values of value ranges, are highly useful for predicting an acute leukemic state of an individual, or for providing a differential diagnosis for acute leukemias. It should be noted that the particular values and ranges shown in Tables 4 and 5 above are for the specific hematology analyzer used for the study, and that calibrations may vary from device to device, even among the same brand and model of device.

After developing the above mentioned ALL and APL prediction models using case set A, they were applied to a totally different set of cases (set B). The performance of these models in this new set of cases is summarized in Table 6.

TABLE 6

| | ALL Model | APL Model |
|---|---|---|
| Sensitivity | 89.36% (correctly identified 42 | 100% (correctly identified |
| | out of 47 acute lymphoblastic | all 10 cases of APL) |
| | leukemia cases) | |
| Specificity | 99.35% (correctly ruled out ALL | 100% (correctly ruled out |
| | in 154 out of 155 cases of other | APL in all 192 cases of |
| | types of acute leukemias) | other types of acute |
| | | leukemias) |

As demonstrated by this study, the systems and methods disclosed herein provide robust modalities for accurately predicting the lineage of unknown cases of acute leukemia, using data that was obtained during a CBC-differential performed by the hematology analyzer DxH 800. The APL prediction model was able to correctly classify all cases of APL in both the test and the validation study sets. As noted above, APL is a hematological emergency. In the vast majority of cases it is a curable disease with the use of Alpha-Transretinoic acid (ATRA), but at the same time any delays in treatment can have devastating consequences due to the severe coagulopathy associated with the accumulation of abnormal promyelocytes. Hence, embodiments of the present invention provide techniques for quickly identifying individuals having this acute leukemia disease, and treatment can be started without having to wait for genetic analysis results or other time consuming tests, thus providing the patient with a reduced risk of an adverse outcome. For these reasons, knowing that the use of decision rule models allow for a blast morphologic analysis which correctly identifies APL cases with 100% sensitivity and specificity certainly can be very reassuring both for the pathologist signing out the case, and for the hematologist prescribing ATRA.

Although the discrimination between ALL and AML may be less time sensitive if compared to the diagnosis of APL, these findings still bring value to the diagnostic process for these cases. For example, nowadays cytogenetic testing by FISH is playing an increasingly important role in the prognostication of acute leukemias, and the use of decision rule models as disclosed herein may allow for the correct FISH probes to be ordered earlier on in the diagnostic process. What is more, in those scenarios where a significant delay is expected before immunophenotyping results are available and the choice of induction therapy will be based on blast morphologic analysis, the discrimination between ALL and AML using decision rule models as disclosed herein can be performed with a much better sensitivity and specificity than human review.

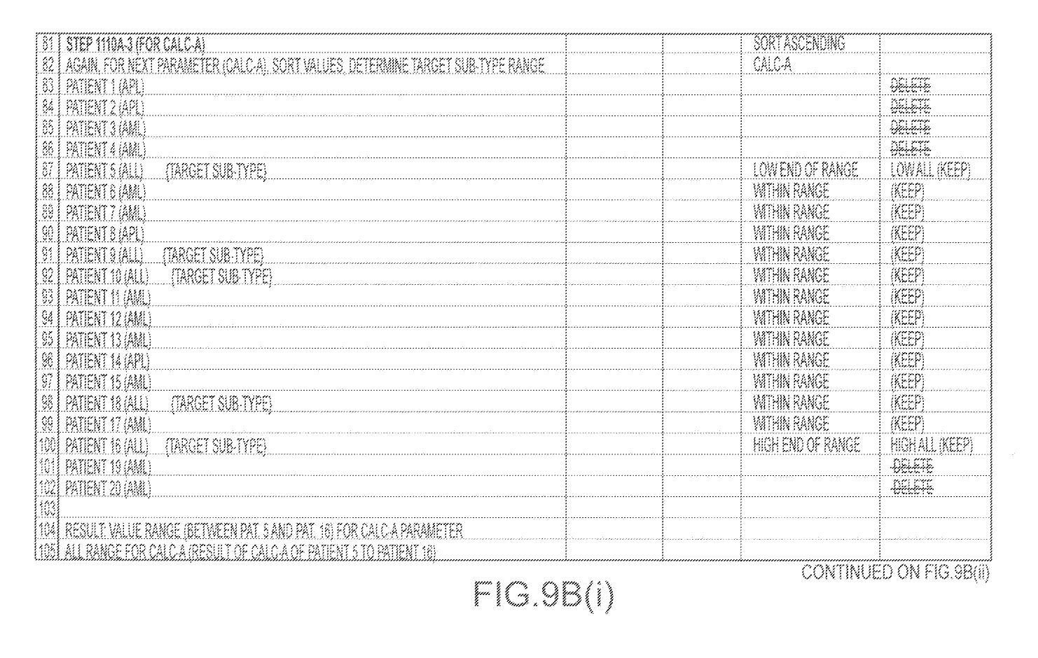

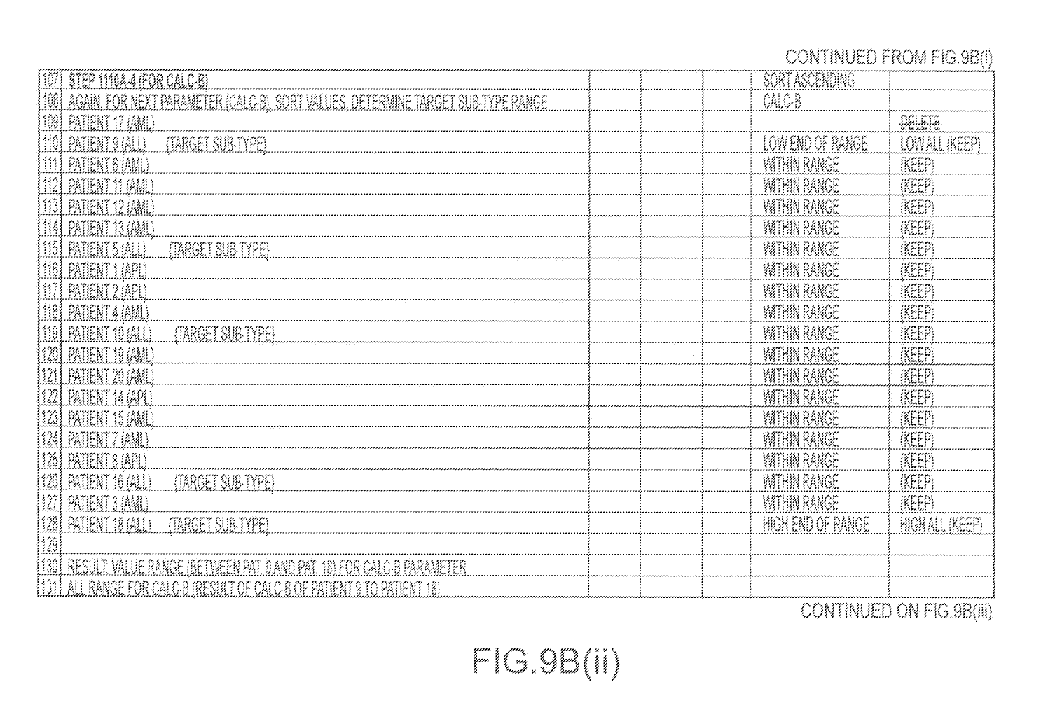

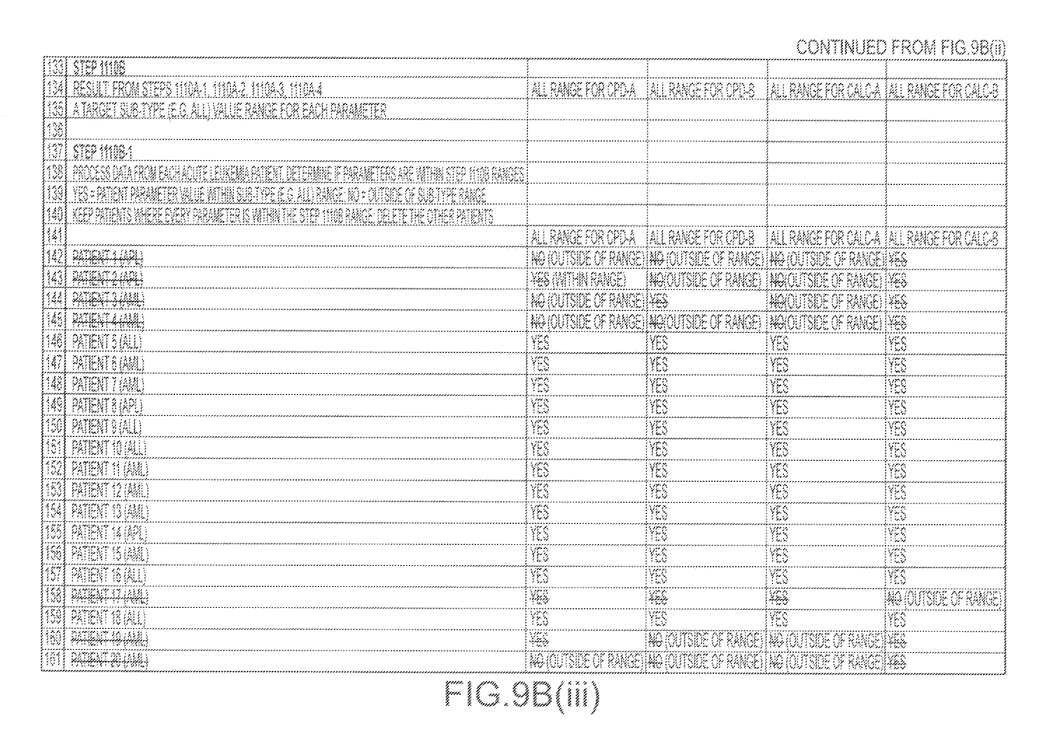

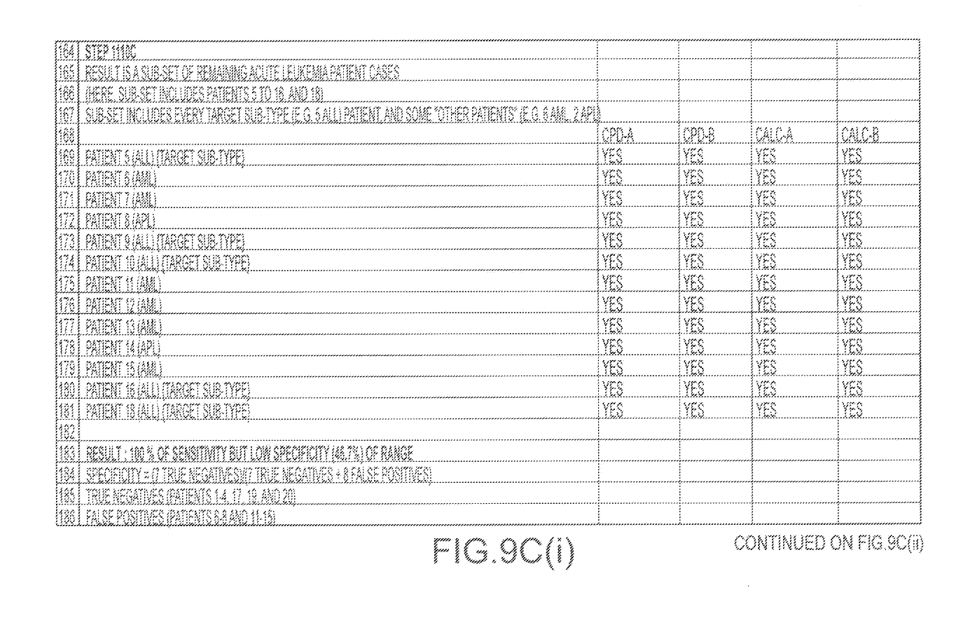

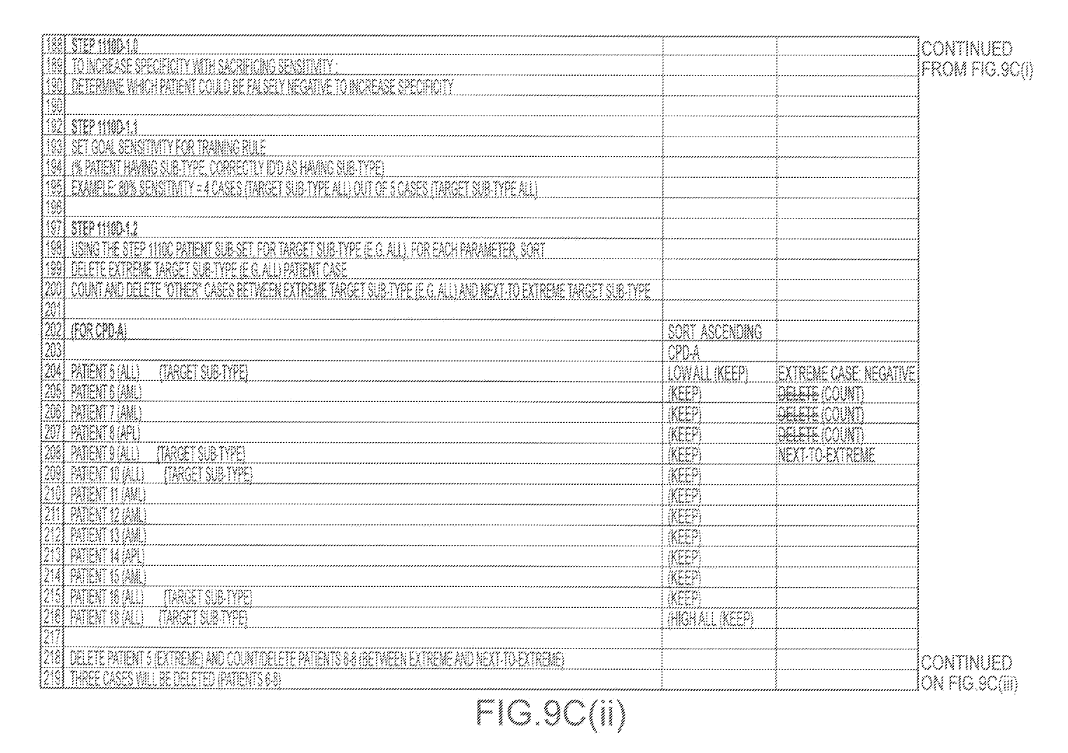

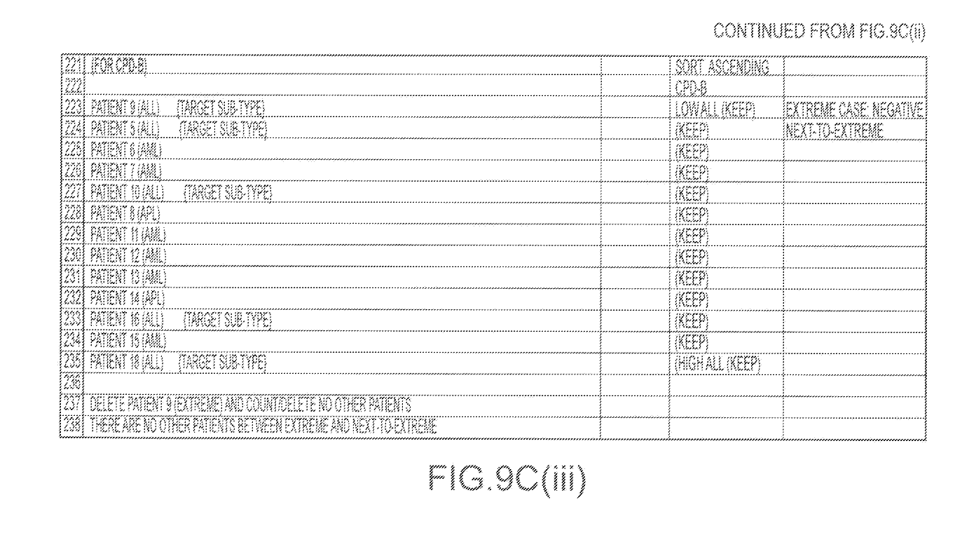

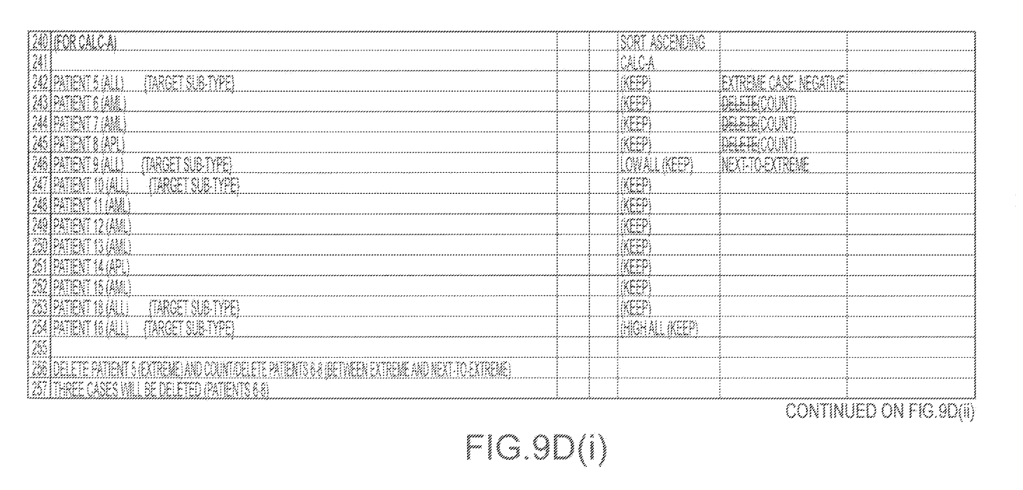

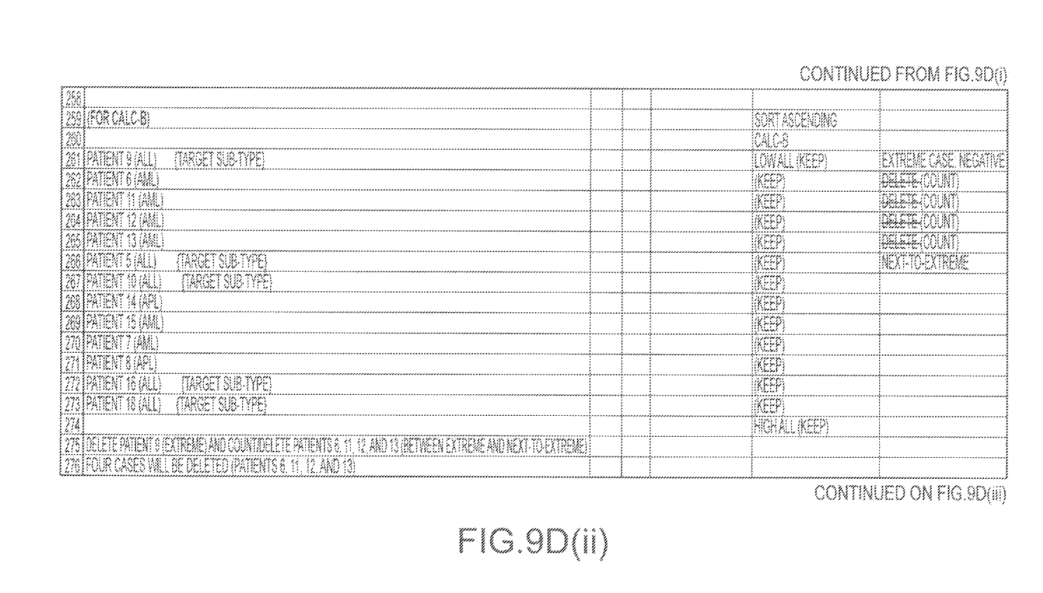

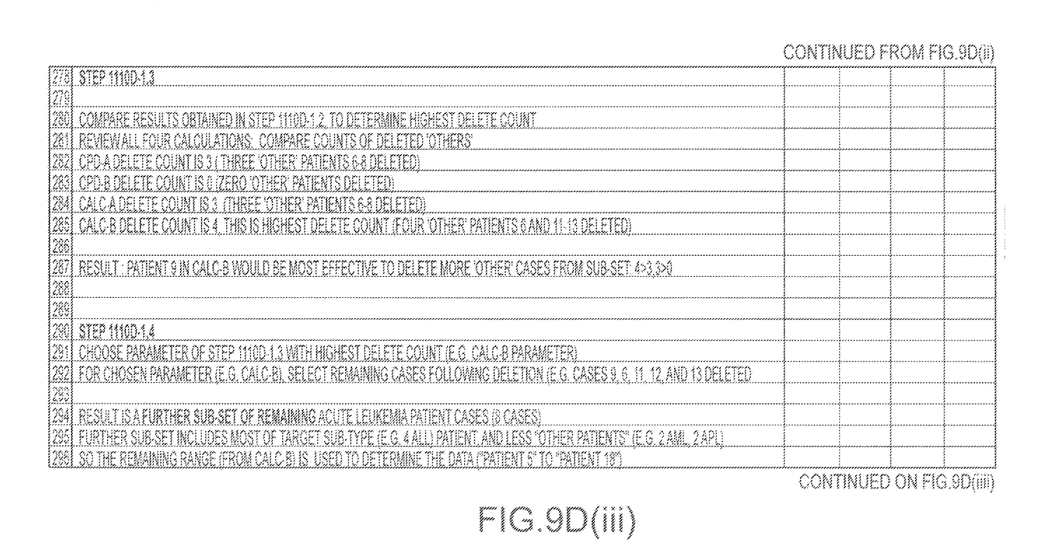

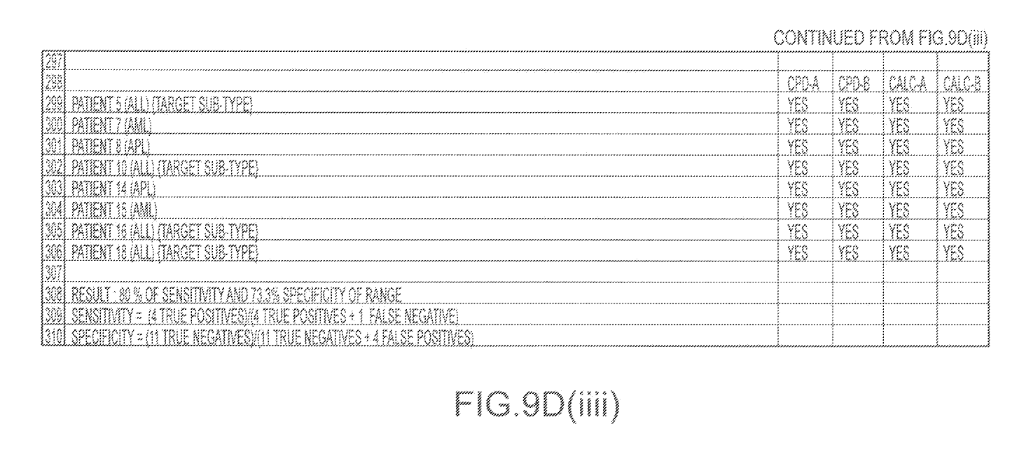

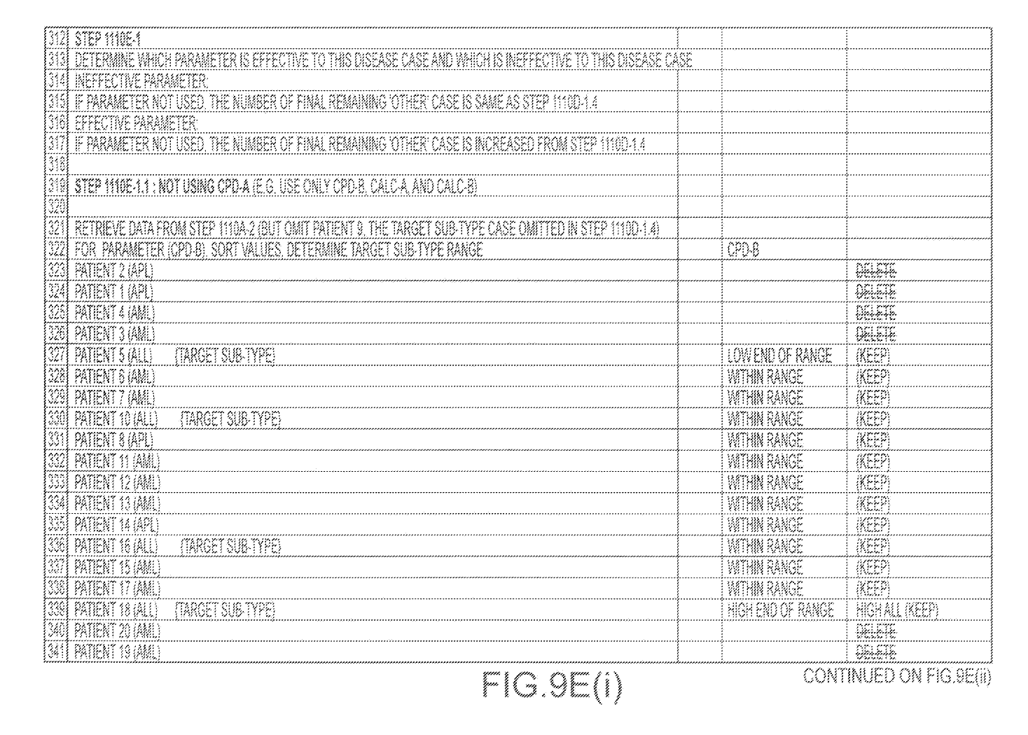

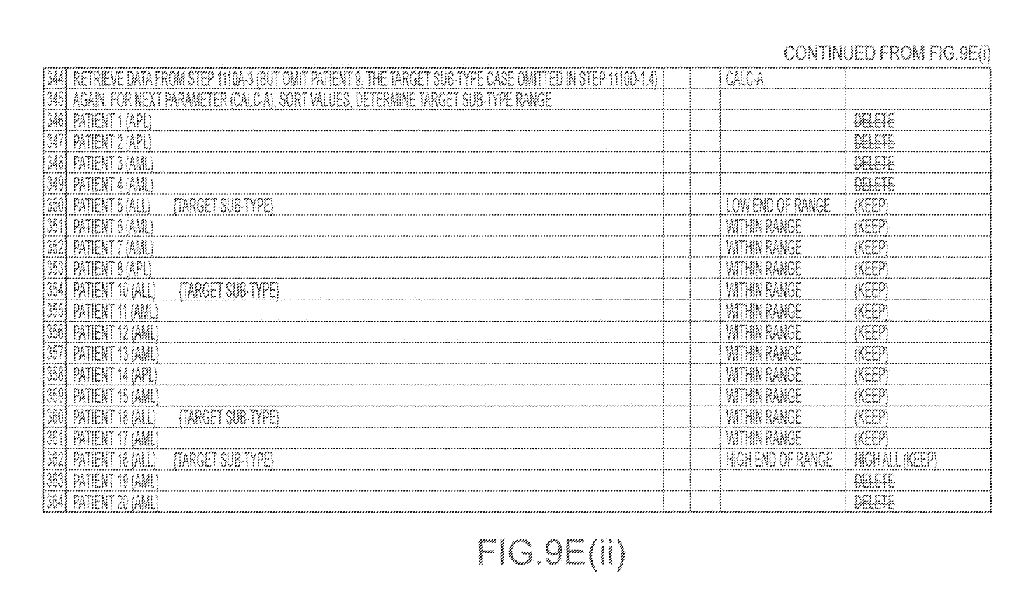

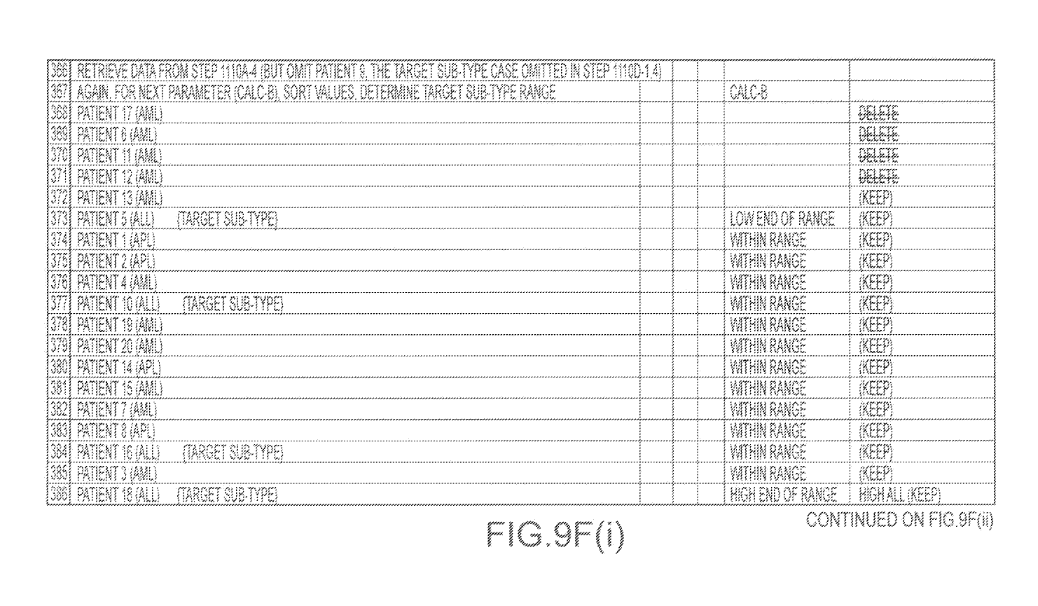

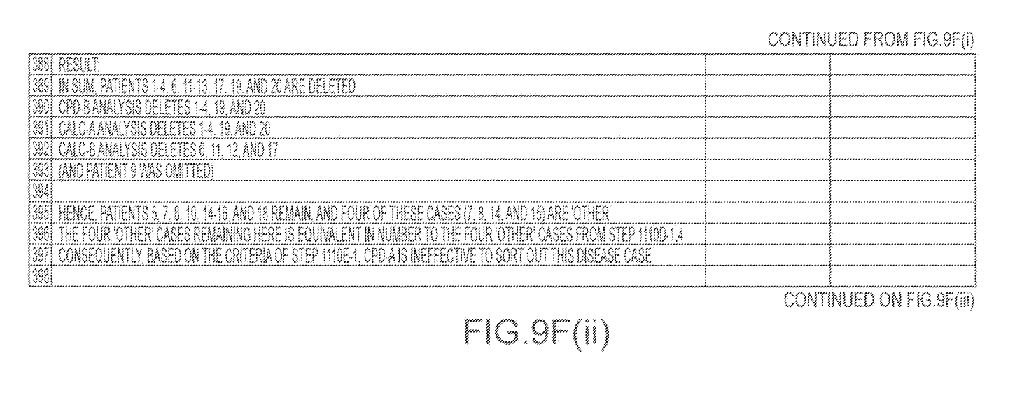

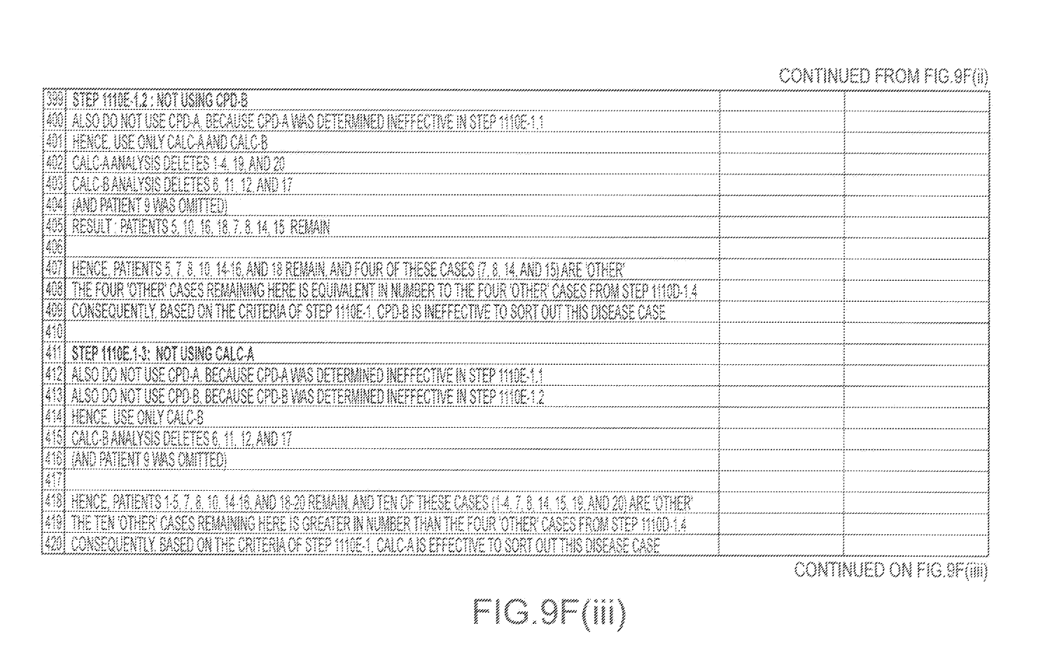

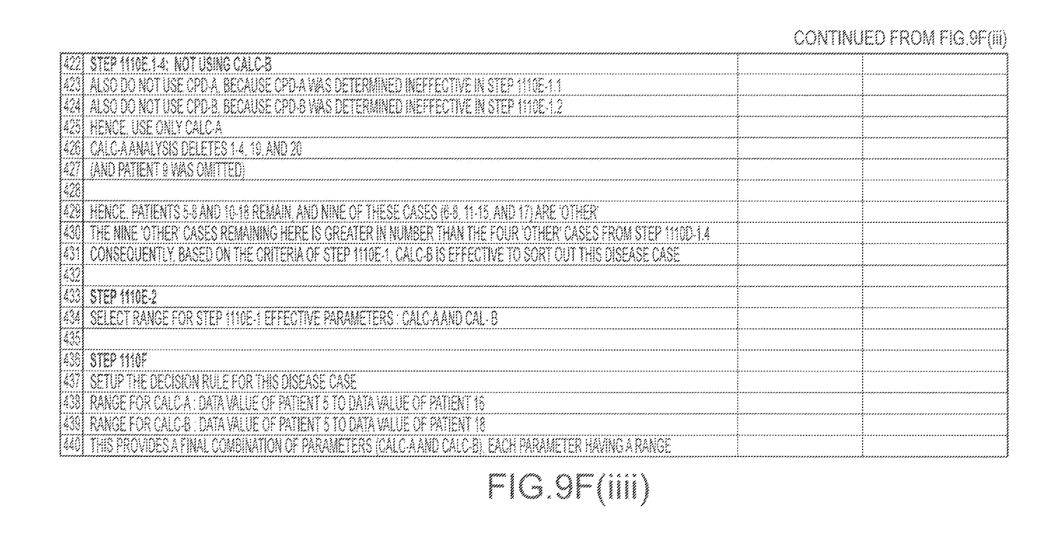

FIGS. 9A(i) to 9F(iiii) depict aspects of an exemplary process for determining which parameters to use as effective parameters for a decision rule, and for determining which values or value ranges to use for the effective parameters of the decision rule. As shown here, the method includes obtaining data for use in developing the decision rule. Such data can be used as an original training set for developing the decision rule. For example, the data may include CBC, CPD, and/or calculated parameter data for patients diagnosed with acute leukemia. In some embodiments, an acute leukemia diagnosis may be based on a patient presenting with greater than 10% blasts in the blood, although other criteria may be used for acute leukemia diagnosis. Exemplary acute leukemia diagnostic and classification techniques are discussed in McKenna “Multifaceted approach to the diagnosis and classification of acute leukemias” Clin. Chem. 2000 August 46(8 Pt 2):1252-9 (2000) and Haferlach et al., “Modern diagnostics in acute leukemias” Crit. Rev. Oncol. Hematol., November 56(2):223-34 (2005), the contents of which are incorporated herein by reference. Typically, the data for use in developing the decision rule corresponds to information obtained by analyzing the individual's biological sample with a cellular analysis technique as described herein. In this way, the particular physiological state of the individual (e.g. acute lymphoblastic leukemia) and the corresponding biological sample data (e.g. CBC, CPD, and/or calculated parameter data) are known. The sum of this data (e.g. full spectrum of values and/or ranges for each parameter) can provide a highly sensitive test. As shown here, the method may also include determining a desired sensitivity for a decision rule. Often, a high sensitivity is desired when false negatives are present, and high specificity is desired when false positives are present. Relatedly, high sensitivity is typically desired when a false negative presents a risk to the patient. High sensitivity tests usually have high false positive rates, and when a reduction in false positives is desired, it is helpful to increase the specificity. The sensitivity can be defined as the percentage of individuals having a specific disease, who are correctly identified as having the disease. Table 7 below provides an exemplary summary for calculating sensitivity, as well as specificity.

TABLE 7

| | Disease Present | Disease Absent |
|---|---|---|
| Test Positive | True Positive (TP) | False Positive (FP) |
| Test Negative | False Negative (FN) | True Negative (TN) |
| Sensitivity | TP/(TP + FN) | |
| Specificity | | TN/(FP + TN) |

By setting a desirable sensitivity, it is possible to increase specificity. In some instances, the sensitivity may be selected based on the particular type of acute leukemia (e.g. ALL, AML, or APL). For example, where very high specificity is desired for a particular disease, it may be helpful to set the desired sensitivity for the decision rule to a lower value. As shown here, the sensitivity and specificity of the decision rule (e.g. combination of the remaining effective parameters and their corresponding values or value ranges) can be calculated.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

While exemplary embodiments have been described in some detail, by way of example and for clarity of understanding, those of skill in the art will recognize that a variety of modification, adaptations, and changes may be employed. Hence, the scope of the present invention should be limited solely by the claims.

What is claimed is:

1. An automated system for predicting an acute leukemia sub-type of an individual diagnosed with acute leukemia based on a biological sample obtained from blood of the individual, the system comprising:
(a) an optical element having a cell interrogation zone;
(b) a flow path configured to deliver a hydrodynamically focused stream of the biological sample toward the cell interrogation zone;
(c) an electrode assembly configured to measure direct current (DC) impedance and radiofrequency (RF) conductivity of cells of the biological sample passing individually through the cell interrogation zone;
(d) a light source oriented to direct a light beam along a beam axis to irradiate the cells of the biological sample individually passing through the cell interrogation zone; and
(e) a light detection assembly optically coupled to the cell interrogation zone so as to measure light scattered by and transmitted through the irradiated cells of the biological sample, the light detection assembly configured to measure:
(i) a first propagated light from the irradiated cells within a first range of angles relative to the light beam axis;
(ii) a second propagated light from the irradiated cells within a second range of angles relative to the light beam axis, the second range being different than the first range; and
(iii) an axial light propagated from the irradiated cells along the beam axis;
(f) wherein the system is configured to correlate a subset of DC impedance, RF conductivity, the first propagated light, the second propagated light, and the axial light measurements from the cells of the biological sample with an acute leukemic sub-type of the individual.

2. The system according to claim 1, wherein the light detection assembly comprises a first sensor zone that measures the first propagated light, a second sensor zone that measures the second propagated light, and a third sensor zone that measures the axial propagated light.

3. The system according to claim 1, wherein the light detection assembly comprises a first sensor that measures the first propagated light, a second sensor that measures the second propagated light, and a third sensor that measures the axial propagated light.

4. The system according to claim 1, wherein the subset comprises:
(i) DC impedance measurements for lymphocytes, monocytes, eosinophils, and non-nucleated red blood cells of the biological sample;
(ii) RF conductivity, ALL, LALS, UMALS, and LMALS measurements for neutrophils of the biological sample;
(iii) a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL);
(iv) a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof;
(v) a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or
(vi) a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample.

5. The system according to claim 1, wherein the subset comprises a calculated parameter based on a function of at least two neutrophil measurements.

6. The system according to claim 5, wherein:
(i) the at least two neutrophil measurements are selected from the group consisting of a neutrophil upper median angle light scatter measurement, a neutrophil median angle light scatter measurement, and a neutrophil lower median angle light scatter measurement; or
(ii) the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement.

7. The system according to claim 1, wherein the subset comprises a calculated parameter based on a function of at least two monocyte measurements.

8. The system according to claim 7, wherein:
(i) the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or
(ii) the calculated parameter comprises a member selected from the group consisting of:
a ratio of a monocyte high frequency current measurement to a monocyte low frequency current measurement,
a ratio of a monocyte low angle light scatter measurement to a monocyte axial light loss measurement,
a ratio of a monocyte low frequency current measurement to a monocyte axial light loss measurement,
a ratio of a monocyte upper median angle light scatter measurement to a monocyte low frequency current measurement,
a ratio of a monocyte low angle light scatter measurement to a monocyte low frequency current measurement,
a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement,
a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and
a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement.

9. The system according to claim 1, wherein the subset comprises a calculated parameter based on a function of at least two eosinophil measurements.

10. The system according to claim 11, wherein:
(i) the at least two eosinophil measurements are selected from the group consisting of an eosinophil lower median angle light scatter measurement, an eosinophil median angle light scatter measurement, and an eosinophil upper median angle light scatter measurement; or
(ii) the calculated parameter comprises a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement.

11. The system according to claim 1, wherein the subset comprises a calculated parameter based on a function of at least two non-nucleated red blood cell measurements.

12. The system according to claim 11, wherein:
(i) the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or
(ii) the calculated parameter comprises a member selected from the group consisting of:
a ratio of a non-nucleated red blood cell lower median angle light scatter measurement to a non-nucleated red blood cell axial light loss measurement,
a ratio of a non-nucleated red blood cell low angle light scatter measurement to a non-nucleated red blood cell axial light loss measurement, and
a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement.

13. The system according to claim 1, wherein the subset comprises:
(a) a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or
(b) a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof.

14. The system according to claim 1, wherein the subset comprises a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL).

15. The system according to claim 14, wherein:
(i) the neutrophil calculated parameter comprises a ratio of a neutrophil high frequency current measurement to a neutrophil axial light loss measurement;
(ii) the lymphocyte calculated parameter comprises a ratio of a lymphocyte lower median angle light scatter measurement to a lymphocyte mean median angle light scatter measurement;
(iii) the eosinophil calculated parameter comprises a ratio of an eosinophil lower median angle light scatter measurement to a eosinophil axial light loss measurement; or
(iv) the non-nucleated red blood cell calculated parameter comprises a ratio of a non-nucleated red blood cell low angle light scatter measurement to a non-nucleated red blood cell low frequency current measurement.

16. The system according claim 1, wherein the biological sample comprises:
(i) a blood sample of the individual; or
(ii) neutrophils, lymphocytes, monocytes, eosinophils, and non-nucleated red blood cells of the individual.

17. The system according to claim 1, wherein the acute leukemic sub-type comprises a member selected from the group consisting of an acute lymphoblastic leukemia sub-type or indication, an acute promyelocytic leukemia sub-type or indication, and an acute myeloid leukemia sub-type or indication.

18. The system according to claim 1, wherein the subset comprises a calculated parameter, wherein the calculated parameter is based on a function of at least two measures of cell population data, and wherein the acute leukemic sub-type is assigned based at least in part on the calculated parameter.

19. The system according to claim 1, wherein the predicted acute leukemic sub-type is an acute lymphoblastic leukemia indication, and the subset comprises a volume parameter (V), a conductivity parameter (C), a low angle light scatter parameter (LALS), a lower median angle light scatter parameter (LMALS), an upper median angle light scatter parameter (UMALS), and an axial light loss parameter (AL2).

20. The system according to claim 1, wherein the predicted acute leukemic sub-type is an acute lymphoblastic leukemia indication, and the subset comprises a neutrophil calculated parameter (NE), a monocyte calculated parameter (MO), an eosinophil calculated parameter (EO), and a non-nucleated red blood cell calculated parameter (NNRBC).

21. The system or method according to claim 20, wherein:
(i) the neutrophil calculated parameter is based on a ratio of a neutrophil upper median angle light scatter parameter to a neutrophil median angle light scatter parameter, the neutrophil median angle light scatter parameter comprising the sum of the neutrophil upper median angle light scatter parameter and a neutrophil lower median angle light scatter parameter; and/or
(ii) wherein the monocyte calculated parameter comprises a member selected from the group consisting of:
a ratio of a monocyte conductivity parameter to a monocyte volume parameter,
a ratio of a monocyte low angle light scatter parameter to a monocyte axial light loss parameter,
a ratio of a monocyte volume parameter to a monocyte axial light loss parameter,
a ratio of a monocyte upper median angle light scatter to a monocyte volume parameter,
a ratio of a monocyte low angle light scatter parameter to a monocyte volume parameter,
a ratio of a monocyte low angle light scatter parameter to a monocyte median angle light scatter parameter, the monocyte median angle light scatter parameter comprising the sum of a monocyte upper median angle light scatter parameter and a monocyte lower median angle light scatter parameter,
a ratio of a monocyte upper median angle light scatter parameter to a monocyte median angle light scatter parameter, the monocyte median angle light scatter parameter comprising the sum of the monocyte upper median angle light scatter parameter and a monocyte lower median angle light scatter parameter, and
a ratio of a monocyte lower median angle light scatter parameter to a monocyte median angle light scatter parameter, the monocyte median angle light scatter parameter comprising the sum of a monocyte upper median angle light scatter parameter and the monocyte lower median angle light scatter parameter; and/or
(iii) wherein the eosinophil calculated parameter comprises a ratio of an eosinophil lower median angle light scatter parameter to an eosinophil median angle light scatter parameter, the eosinophil median angle light scatter parameter comprising the sum of an eosinophil upper median angle light scatter parameter and the eosinophil lower median angle light scatter parameter; and/or
(iv) wherein the non-nucleated red blood cell calculated parameter comprises a member selected from the group consisting of:
a ratio of a non-nucleated red blood cell lower median angle light scatter parameter to a non-nucleated red blood cell axial light loss parameter,
a ratio of a non-nucleated red blood cell low angle light scatter parameter to a non-nucleated red blood cell axial light loss parameter, and
a ratio of a non-nucleated red blood cell lower median angle light scatter parameter to a non-nucleated red blood cell median angle light scatter parameter, the non-nucleated red blood cell median angle light scatter parameter comprising the sum of a non-nucleated red blood cell upper median angle light scatter parameter and the non-nucleated red blood cell lower median angle light scatter parameter.

22. The system according to claim 1, wherein the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2).

23. The system according to claim 1, wherein the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC).

24. The system according to claim 1, wherein the subset is determined based on a pre-defined specificity and/or sensitivity for acute leukemia.

25. The system according to claim 1, wherein the subset comprises a calculated parameter for identifying acute lymphoblastic leukemia or a calculated parameter for identifying acute promyelocyte leukemia.

26. A method for predicting an acute leukemia sub-type of an individual based on a biological sample obtained from blood of the individual, the method comprising:
(a) delivering a hydrodynamically focused stream of the biological sample toward a cell interrogation zone of an optical element;
(b) measuring, with an electrode assembly, current (DC) impedance and radiofrequency (RF) conductivity of cells of the biological sample passing individually through the cell interrogation zone;
(c) irradiating, with a light beam having an axis, cells of the biological sample individually passing through the cell interrogation zone;
(d) measuring, with a light detection assembly, a first propagated light from the irradiated cells within a first range of angles relative to the beam axis;
(e) measuring, with the light detection assembly, a second propagated light from the irradiated cells within a second range of angles relative to the beam axis, the second range being different than the first range;
(f) measuring, with the light detection assembly, axial light propagated from the irradiated cells along the beam axis; and
(g) correlating a subset of DC impedance, RF conductivity, the first propagated light, the second propagated light, and the axial light measurements from the cells of the biological sample with a predicted acute leukemic sub-type of the individual.

27. The method according to claim 26, wherein the light detection assembly comprises a first sensor zone that measures the first propagated light, a second sensor zone that measures the second propagated light, and a third sensor zone that measures the axial propagated light.

28. The method according to claim 26, wherein the light detection assembly comprises a first sensor that measures the first propagated light, a second sensor that measures the second propagated light, and a third sensor that measures the axial propagated light.

29. The method according to claim 26, wherein the subset comprises:
(i) DC impedance measurements for lymphocytes, monocytes, eosinophils, and non-nucleated red blood cells of the biological sample;
(ii) RF conductivity, ALL, LALS, UMALS, and LMALS measurements for neutrophils of the biological sample;
(iii) a neutrophil measurement, a monocyte measurement, an eosinophil measurement, a non-nucleated red blood cell measurement, or a combination of two or more thereof, and wherein the acute leukemic sub-type comprises acute lymphoblastic leukemia (ALL);
(iv) a standard deviation high frequency current neutrophil measurement, a mean upper median angle light scatter neutrophil measurement, a standard deviation upper median angle light scatter neutrophil measurement, a standard deviation low angle light scatter neutrophil measurement, standard deviation axial light loss neutrophil measurement, a mean low frequency current lymphocyte measurement, a mean high frequency current lymphocyte measurement, a standard deviation high frequency current lymphocyte measurement, a mean low angle light scatter lymphocyte measurement, a mean axial light loss lymphocyte measurement, a mean low frequency current monocyte measurement, a standard deviation low frequency current monocyte measurement, a mean high frequency current monocyte measurement, a standard deviation high frequency current monocyte measurement, a mean lower median angle light scatter monocyte measurement, a mean low angle light scatter monocyte measurement, a mean axial light loss monocyte measurement, a mean low frequency current eosinophil measurement, a standard deviation low frequency eosinophil measurement, a mean lower median angle light scatter eosinophil measurement, a mean high frequency current non-nucleated red blood cell measurement, a standard deviation high frequency current non-nucleated red blood cell measurement, a standard deviation upper median angle light scatter non-nucleated red blood measurement, or a combination of two or more thereof;
(v) a neutrophil calculated parameter, a monocyte calculated parameter, an eosinophil calculated parameter, a non-nucleated red blood cell calculated parameter, or a combination of two or more thereof, and wherein the acute leukemic sub-type comprises acute lymphoblastic leukemia (ALL); or
(vi) a calculated parameter based on a function of at least two parameters selected from the group consisting of the axial light loss measurement of the sample, a low frequency current measurement of the sample, a high frequency current measurement of the sample, a low angle light scatter measurement of the sample, a lower median angle light scatter measurement of the sample, and an upper median angle light scatter measurement of the sample.

30. The method according to claim 26, wherein the subset comprises a calculated parameter based on a function of at least two neutrophil measurements.

31. The method according to claim 30, wherein:
(i) the at least two neutrophil measurements are selected from the group consisting of a neutrophil upper median angle light scatter measurement, a neutrophil median angle light scatter measurement, and a neutrophil lower median angle light scatter measurement; or
(ii) the calculated parameter is based on a ratio of a neutrophil upper median angle light scatter measurement to a neutrophil median angle light scatter measurement, the neutrophil median angle light scatter measurement comprising the sum of the neutrophil upper median angle light scatter measurement and a neutrophil lower median angle light scatter measurement.

32. The method according to claim 26, wherein the subset comprises a calculated parameter based on a function of at least two monocyte measurements.

33. The method according to claim 32, wherein:
(i) the at least two monocyte measurements are selected from the group consisting of a monocyte high frequency current measurement, a monocyte low frequency current measurement, a monocyte axial light loss measurement, a monocyte median angle light scatter measurement, a monocyte low angle light scatter measurement, a monocyte upper median angle light scatter measurement, and a monocyte lower median angle light scatter measurement; or
(ii) the calculated parameter comprises a member selected from the group consisting of:
a ratio of a monocyte high frequency current measurement to a monocyte low frequency current measurement,
a ratio of a monocyte low angle light scatter measurement to a monocyte axial light loss measurement,
a ratio of a monocyte low frequency current measurement to a monocyte axial light loss measurement,
a ratio of a monocyte upper median angle light scatter measurement to a monocyte low frequency current measurement,
a ratio of a monocyte low angle light scatter measurement to a monocyte low frequency current measurement,
a ratio of a monocyte low angle light scatter measurement to a monocyte median angle light scatter measurement, the monocyte median angle light scatter measurement comprising the sum of a monocyte upper median angle light scatter measurement and a monocyte lower median angle light scatter measurement,
a ratio of a monocyte upper median angle light scatter measurement to a monocyte median angle light scatter measurement, the monocyte median angle light scatter measurement comprising the sum of the monocyte upper median angle light scatter measurement and a monocyte lower median angle light scatter measurement, and
a ratio of a monocyte lower median angle light scatter measurement to a monocyte median angle light scatter measurement, the monocyte median angle light scatter measurement comprising the sum of a monocyte upper median angle light scatter measurement and the monocyte lower median angle light scatter measurement.

34. The method according to claim 26, wherein the subset comprises a calculated parameter based on a function of at least two eosinophil measurements.

35. The method according to claim 34, wherein:
(i) the at least two eosinophil measurements are selected from the group consisting of an eosinophil lower median angle light scatter measurement, an eosinophil median angle light scatter measurement, and an eosinophil upper median angle light scatter measurement; or
(ii) the calculated parameter comprises a ratio of an eosinophil lower median angle light scatter measurement to an eosinophil median angle light scatter measurement, the eosinophil median angle light scatter measurement comprising the sum of an eosinophil upper median angle light scatter measurement and the eosinophil lower median angle light scatter measurement.

36. The method according to claim 26, wherein the subset comprises a calculated parameter based on a function of at least two non-nucleated red blood cell measurements.

37. The method according to claim 36, wherein:
(i) the at least two non-nucleated red blood cell measurements are selected from the group consisting of a non-nucleated red blood cell lower median angle light scatter measurement, a non-nucleated red blood cell axial light loss measurement, a non-nucleated red blood cell low angle light scatter measurement, a non-nucleated red blood cell median angle light scatter measurement, and a non-nucleated red blood cell upper median angle light scatter measurement; or
(ii) the calculated parameter comprises a member selected from the group consisting of:
a ratio of a non-nucleated red blood cell lower median angle light scatter measurement to a non-nucleated red blood cell axial light loss measurement,
a ratio of a non-nucleated red blood cell low angle light scatter measurement to a non-nucleated red blood cell axial light loss measurement, and
a ratio of a non-nucleated red blood cell lower median angle light scatter measurement to a non-nucleated red blood cell median angle light scatter measurement, the non-nucleated red blood cell median angle light scatter measurement comprising the sum of a non-nucleated red blood cell upper median angle light scatter measurement and the non-nucleated red blood cell lower median angle light scatter measurement.

38. The method according to claim 26, wherein the subset comprises:
(a) a neutrophil measurement, a monocyte measurement, an eosinophil measurement, a non-nucleated red blood cell measurement, or a combination of two or more thereof, and wherein the acute leukemic sub-type comprises acute promyelocytic leukemia (APL); or
(b) a mean low angle light scatter neutrophil measurement, a mean median angle light scatter neutrophil measurement, a mean low frequency current lymphocyte measurement, a mean low frequency current monocyte measurement, a mean lower median angle light scatter monocyte measurement, a standard deviation axial light loss monocyte measurement, a mean median angle light scatter eosinophil measurement, a mean low frequency current non-nucleated red blood cell measurement, a standard deviation median angle light scatter non-nucleated red blood cell measurement, or a combination of two or more thereof.

39. The method according to claim 26, wherein the subset comprises a neutrophil calculated parameter, a lymphocyte calculated parameter, an eosinophil calculated parameter, a non-nucleated red blood cell calculated parameter, or a combination of two or more thereof, and wherein the acute leukemic sub-type comprises acute promyelocytic leukemia (APL).

40. The method according to claim 39, wherein:
(i) the neutrophil calculated parameter comprises a ratio of a neutrophil high frequency current measurement to a neutrophil axial light loss measurement;
(ii) the lymphocyte calculated parameter comprises a ratio of a lymphocyte lower median angle light scatter measurement to a lymphocyte mean median angle light scatter measurement;
(iii) the eosinophil calculated parameter comprises a ratio of an eosinophil lower median angle light scatter measurement to a eosinophil axial light loss measurement; or
(iv) the non-nucleated red blood cell calculated parameter comprises a ratio of a non-nucleated red blood cell low angle light scatter measurement to a non-nucleated red blood cell low frequency current measurement.

41. The method according to claim 26, wherein the biological sample comprises:
a blood sample of the individual; or
neutrophils, lymphocytes, monocytes, eosinophils, and non-nucleated red blood cells of the individual.

42. The method according to claim 26, wherein the acute leukemic sub-type comprises a member selected from the group consisting of an acute lymphoblastic leukemia sub-type or indication, an acute promyelocytic leukemia sub-type or indication, and an acute myeloid leukemia sub-type or indication.

43. The method according to claim 26, wherein the subset comprises a calculated parameter, wherein the calculated parameter is based on a function of at least two measures of cell population data, and wherein the acute leukemic sub-type is assigned based at least in part on the calculated parameter.

44. The method according to claim 26, wherein the predicted acute leukemic sub-type is an acute lymphoblastic leukemia indication, and the subset comprises a volume parameter (V), a conductivity parameter (C), a low angle light scatter parameter (LALS), a lower median angle light scatter parameter (LMALS), an upper median angle light scatter parameter (UMALS), and an axial light loss parameter (AL2).

45. The method according to claim 26, wherein the predicted acute leukemic sub-type is an acute lymphoblastic leukemia indication, and the subset comprises a neutrophil calculated parameter (NE), a monocyte calculated parameter (MO), an eosinophil calculated parameter (EO), and a non-nucleated red blood cell calculated parameter (NNRBC).

46. The method according to claim 45, wherein:
(i) the neutrophil calculated parameter is based on a ratio of a neutrophil upper median angle light scatter parameter to a neutrophil median angle light scatter parameter, the neutrophil median angle light scatter parameter comprising the sum of the neutrophil upper median angle light scatter parameter and a neutrophil lower median angle light scatter parameter; and/or
(ii) wherein the monocyte calculated parameter comprises a member selected from the group consisting of:
a ratio of a monocyte conductivity parameter to a monocyte volume parameter,
a ratio of a monocyte low angle light scatter parameter to a monocyte axial light loss parameter,
a ratio of a monocyte volume parameter to a monocyte axial light loss parameter,
a ratio of a monocyte upper median angle light scatter to a monocyte volume parameter,
a ratio of a monocyte low angle light scatter parameter to a monocyte volume parameter,
a ratio of a monocyte low angle light scatter parameter to a monocyte median angle light scatter parameter, the monocyte median angle light scatter parameter comprising the sum of a monocyte upper median angle light scatter parameter and a monocyte lower median angle light scatter parameter,
a ratio of a monocyte upper median angle light scatter parameter to a monocyte median angle light scatter parameter, the monocyte median angle light scatter parameter comprising the sum of the monocyte upper median angle light scatter parameter and a monocyte lower median angle light scatter parameter, and
a ratio of a monocyte lower median angle light scatter parameter to a monocyte median angle light scatter parameter, the monocyte median angle light scatter parameter comprising the sum of a monocyte upper median angle light scatter parameter and the monocyte lower median angle light scatter parameter; and/or
(iii) wherein the eosinophil calculated parameter comprises a ratio of an eosinophil lower median angle light scatter parameter to an eosinophil median angle light scatter parameter, the eosinophil median angle light scatter parameter comprising the sum of an eosinophil upper median angle light scatter parameter and the eosinophil lower median angle light scatter parameter; and/or
(iv) wherein the non-nucleated red blood cell calculated parameter comprises a member selected from the group consisting of:
a ratio of a non-nucleated red blood cell lower median angle light scatter parameter to a non-nucleated red blood cell axial light loss parameter,
a ratio of a non-nucleated red blood cell low angle light scatter parameter to a non-nucleated red blood cell axial light loss parameter, and
a ratio of a non-nucleated red blood cell lower median angle light scatter parameter to a non-nucleated red blood cell median angle light scatter parameter, the non-nucleated red blood cell median angle light scatter parameter comprising the sum of a non-nucleated red blood cell upper median angle light scatter parameter and the non-nucleated red blood cell lower median angle light scatter parameter.

47. The method according to claim 26, wherein the predicted acute leukemic sub-type is an acute promyelocytic leukemia indication determined based on a volume parameter (V), a conductivity parameter (C), a low angle light scatter parameter (LALS), a lower median angle light scatter parameter (LMALS), an upper median angle light scatter parameter (UMALS), and an axial light loss parameter (AL2).

48. The method according to claim 26, wherein the predicted acute leukemic sub-type is an acute promyelocytic leukemia indication based on a neutrophil calculated parameter (NE), a lymphocyte calculated parameter (LY), an eosinophil calculated parameter (EO), and a non-nucleated red blood cell calculated parameter (NNRBC).

49. The method according to claim 26, wherein the subset is determined based on a pre-defined specificity and/or sensitivity for acute leukemia.

50. The method according to claim 26, wherein the subset comprises a calculated parameter for identifying acute lymphoblastic leukemia or a calculated parameter for identifying acute promyelocyte leukemia.

51. An automated method of evaluating a biological sample from an individual, the method comprising:
obtaining, using a particle analysis system, light scatter data, light absorption data, and current data for the biological sample as the sample passes through an aperture;
determining a cell population data profile for the biological sample based on assay results obtained from the particle analysis system;
determining, using a computer system, an acute leukemia sub-type physiological status for the individual according to a calculated parameter, wherein the calculated parameter is based on a function of at least two cell population data measures of the cell population data profile; and
outputting the acute leukemia sub-type physiological status.

52. An automated system for predicting an acute leukemia sub-type of an individual, the system comprising:
(a) a processor; and
(b) a storage medium comprising a computer application that, when executed by the processor, is configured to cause the system to:
(i) access cell population data concerning a biological sample of the individual;
(ii) use the cell population data to determine a predicted sub-type of an acute leukemia of the individual; and
(iii) output from the processor information relating to the predicted sub-type of the leukemia.

53. An automated method for predicting an acute leukemia sub-type of an individual, the method comprising:
(a) accessing cell population data concerning a biological sample of the individual by executing, with a processor, a storage medium comprising a computer application;
(b) using the cell population data to determine a predicted sub-type of an acute leukemia of the individual by executing, with the processor, the storage medium; and
(c) outputting from the processor information relating to the predicted sub-type of the leukemia.
